(19) United States
(12) Patent Application Publication
(10) Pub. No.: US 2023/0286552 A1
(43) Pub. Date: Sep. 14, 2023

(54) Apparatus and Applications for Magnetic Levitation and Movement Using Offset Magnetic Arrays

(71) Applicants: John M. Baker, Hayward, CA (US); Remigio Perales, Oberlin, OH (US); Clifford J. P. Gilman, New Castle, NH (US)

(72) Inventors: John M. Baker, Hayward, CA (US); Remigio Perales, Oberlin, OH (US); Clifford J. P. Gilman, New Castle, NH (US)

(73) Assignees: US Positronix Inc., Oberlin, OH (US); SRI International, Menlo Park, CA (US)

(21) Appl. No.: 18/007,405

(22) PCT Filed: Aug. 11, 2021
(86) PCT No.: PCT/US2021/045457

§ 371 Date: Jan. 30, 2023

Related U.S. Application Data
(60) Provisional application No. 62/706,355, filed on Aug. 11, 2020.
(60) Provisional application No. 63/199,269, filed on Dec. 16, 2020.

(51) Int. Cl. B61B 13/08

(52) U.S. Cl. CPC B61B 13/08

(57) ABSTRACT

We use permanent magnets to levitate and transport heavy loads. A bed of permanent magnets is selectively actuated to levitate an array of magnets positioned above the bed, such that the magnets in the levitated array are opposed to the actuated magnets, and of the same magnetic pole, thereby creating a repulsive force. The actuated magnets are offset from magnets in the bed of permanent magnets that have not been actuated, thereby imparting maximum levitation forces to the magnets in the levitated array.

Our systems use magnetic repulsive force for levitating and transporting goods across a warehouse, simulating walking or running such as on a treadmill or in a virtual gaming platform, and for transporting people such as on a moving sidewalk. Our systems are electrical machines for holding or levitating devices using magnetic levitation, and also use permanent magnets to transmit power wirelessly.

### BACKGROUND OF THE INVENTION

### Description of the Related Art

Magnetic levitation is an ancient concept where objects are lifted using repulsion or attraction between two magnets. Any child playing with magnets finds that two magnets can push each other away, and may try to arrange the magnets so that one magnet floats in the air above the other magnet. They soon find that getting a magnet to float stably in the air is difficult or impossible in practice.

One example of a system that uses permanent magnets to levitate light objects for display was disclosed by Neal in the 1940's (U.S. Pat. No. 2,323,837A.) This system can only lift light objects, like a shoe, and there is a serious question of whether the lifted object would be stable without more complexity (see U.S. Pat. No. 5,168,183A and later discussion of Earnshaw's theorem herein.)

Another example of a system using permanent magnets to levitate light objects was disclosed by Harrigan in the late 1970's (U.S. Pat. No. 4,382,245.) This system uses a bowl-shaped underlying magnet and requires the light levitated object to spin in order to be stable.

An array of permanent magnets, rather than a one-piece magnet, is sometimes used for certain applications. A Halbach array is an arrangement of magnets that greatly increases the magnetic field on one side of the array, while greatly decreasing the magnetic field on the opposite side. The various individual magnets in a Halbach array must be oriented such that each magnet has a magnetic field that points 90 degrees differently from each magnet that is touching it.

Halbach arrays are tricky to assemble, because the differing magnetic orientations required make the component magnets repel each other. It can be difficult to ensure that the array will hold together. Also, each magnet's force acts to demagnetize its neighbor over time, depending on the coercivity of the magnetic material. Further, heating up a magnet generally reduces its coercivity.

Whitehead disclosed a levitation system using permanent magnets for lift and electromagnets with sensors for feedback control for stability in the early 1990's (U.S. Pat. No. 5,168,183A), which could lift light toys. Davis joined Whitehead to describe an improved levitation system, also using permanent magnets for lift and electromagnets with sensors for feedback control for stability in 2009 (U.S. Pat. No. 7,505,203), which claimed to have better stability and could lift the same light toys at a lower cost and required less magnetic material.

It is also possible to generate levitation forces using a rotating magnet array to generate eddy currents in a metallic plate. An example of this in practice is the Hendo hoverboard, which has disc-shaped hover engines which are electromagnets, and which also induce eddy currents and a repelling magnetic field in a paramagnetic copper or aluminum floor. The Hendo hoverboard can only levitate over the paramagnetic floor, and both the engines and the paramagnetic floor get very hot during use. The engines on the hoverboard use a lot of energy, and the batteries required add mass to the hoverboard, which must then be levitated.

Levitating trains can travel much faster than traditional vehicles, because wheels are not needed, and thus there is no friction between the vehicle and the rails/road to overcome. People have been working on magnetic levitation for high speed trains for over 100 years. These systems use a combination of permanent magnets, electromagnets and sometimes superconducting magnets. The use of superconducting magnets requires cryogenic systems which are prohibitively expensive for all but the largest industrial applications (e.g. maglev trains.) The use of electromagnets is also problematic in that it requires a large amount of electrical power to levitate relatively heavy objects. Halbach arrays of permanent magnets can be used in maglev train tracks.

Transport of objects by magnetic levitation is mostly still in the realm of science fiction. Imagine flipping a switch, causing a pallet of boxes to be levitated above the floor, so that you can then push it along with no friction and only the resistance of inertia and air. This transport system does not exist largely because lifting heavy loads with electromagnets is so expensive, energy intensive and heat producing.

Small transport systems using magnetic levitation do exist. Linear motors are used for maglev trains, allowing movement in one dimension. In 1968, Bruce Sawyer patented the first planar motor, or Sawyer motor, which could move an object with very little mass in 2 dimensions across a plane. This type of system is used for precision lithography of microchips, so the objects commonly levitated continue to have very little mass. Planar Motor Inc. currently offers a planar motor levitation system which claims to be able to lift up objects with a mass of up to 14 kg. Each of these systems use electromagnetic coils to create repulsive magnetic lift force.

Omnidirectional treadmills, like the Infinadeck shown in the movie Ready Player One, are available but do not use magnetic levitation. The Infinadeck's mechanism is like a conveyer belt of smaller perpendicular conveyer belts: a macro conveyer belt moves north or south, for example, and smaller strips on the north/south moving conveyer belt individually move east or west. Although this omnidirectional treadmill approximates walking and slow running motion in 2 dimensions, it suffers from a number of problems. Direct drive treadmills, such as the Infinadeck, face problems of friction and inertia. The presence of friction limits the speed at which the direct drive treadmill can react to changes in the user's motion, requiring a relatively large drive motor to overcome the frictional drag on the system. Similarly, the inertia of the direct drive motor's belts and pulleys limits the reaction time of the system.

There are primarily three problems with magnetic levitation using permanent magnets for an application intended to lift more than a few pounds:
1. Earnshaw's theorem—It has been shown mathematically that it is impossible to stably levitate an object using any stationary arrangement of permanent magnets.
2. Poor Scaling—As the lateral size of a magnet of fixed thickness is increased, the levitation force does not scale with area. To maintain a large force per unit area, the thickness of a magnet must be scaled with its lateral size which leads to a relatively heavy system with limited applicability.
3. Small magnet over a larger magnet—If a small magnet (small in lateral dimensions) is levitated using magnetic repulsion over a magnet of equal lateral dimension, a relatively large levitation force is created. However, if one lateral dimension of one of the magnets is increased and the thickness of both magnets kept constant, then the levitation force is decreased, and the levitation force is decreased more dramatically if both lateral dimensions are increased on one of the magnets. This implies that it is difficult to levitate a relatively small magnet over a much larger magnet.

### BRIEF DESCRIPTION OF THE INVENTION

This invention uses permanent magnets to generate the forces necessary for magnetic levitation. The three primary problems with magnetic levitation using permanent magnets for these applications are addressed: Earnshaw's theorem of instability, poor scaling and difficulties involving levitating a small magnet over a larger magnet.

The inventors developed a system which includes a bed of magnets, where each individual magnet is connected to a linear actuator, which moves the magnet up and down vertically. Another smaller array of one or more magnets, to be magnetically levitated, is placed above the bed of actuated magnets. By selectively moving individual or groups of actuated magnets from the bed up into subarrays and back down, an offset subarray is maintained directly underneath the upper array, levitating it. In addition, this actuation can serve both to stabilize the levitation and to move the upper levitated array laterally.

This system takes advantage of the discovery that, when comparing a large magnet of given surface area and thickness with an array of smaller magnets which collectively has the same surface area and thickness as the large magnet, the array of magnets with spacing between magnets provides more lift than the solid magnet. The system also takes advantage of the discovery that when a lower array is close to the size of an upper levitated array, it provides better lift than when the lower array is bigger than the upper array. The system uses permanent magnets as much as possible, to reduce total power usage and to avoid or limit the need for power and batteries on the levitated portion of the system.

This system also takes advantage of the discovery that, when using an array of spaced magnets rather than a solid magnet, the lift forces generated at small distances (less than 1 cm, as an example when using ¼ inch thick neodymium magnets) exceed the lift forces generated by a solid magnetic plate of the same thickness and surface area. Therefore, for levitation applications, especially those with vertical impulse forces, this enhanced levitation force at small distances helps to ensure that the system is protected from collisions between the lower array of magnets generating the lift force, and the levitated magnetic array, or levitated platform. Furthermore, for levitating very heavy objects at small distances (less than ¼ cm as an example), the spaced smaller magnet array system performance is vastly superior in lift force than solid magnetic plates of the same dimension.

This system further uses vertical (z) movement of the lower magnets to cause movement, acceleration and deceleration in the x-y plane, as well as stability adjustments for the levitated portion. Finally, it can take advantage of the discovery that a lower array of a given size with center magnets removed can lift an upper levitated array of approximately the same size which also has its center magnets removed, with about as much force as a lower array can lift an upper array when both arrays are full of magnets.

The inventors have also created an array of magnets, spaced such that when permanently interlocked with each other into an array, create both an N facing force on one side, and an S facing force on the other side of the array that exceed the N and S facing repulsion forces of a flat plate permanent magnet of the same size. This creates a magnetic system that has strong repulsive forces on either side of the array. Therefore, this arrangement provides greater forces, requires less magnetic material, is lighter weight, and lower cost than alternative constructions.

We further describe applications for using repulsive magnetic force, including levitation for transport, recreation, and power transfer, using the innovative mechanism and concepts described in detail herein.

A transport system uses repulsive magnetic force to levitate light loads as well as heavy loads from pounds to thousands of pounds, and allows the loads to travel along without any friction between the floor and the load. The transport system can be as simple as a path-shaped array of permanent magnets with rails on each side, along which a user pushes a cargo container with its own magnets on its bottom surface, between an origin point and a destination. This simple transport system would require no power once the load has been placed upon the transport system, except for the effort of the user to control and push the load along the path.

This transport system can be made more versatile, complex and automatic in many ways, each upgrade requiring some power. Actuated permanent magnets in the base path, meaning the magnets move up and down to form raised subarrays which are vertically offset from the remainder of the magnets in the base path, can provide additional levitation force to the cargo container, and also can cause the container to move forward or backward, turn, speed up, slow down or stop.

Two separate definitions of the word “offset” are appropriate to describe the raised lower subarrays. A more obscure definition, “displacement,” or “an abrupt change in the dimension or profile of an object” (Merriam Webster) describes the shape of the raised subarray—the offset subarray magnets are raised substantially above the lower bed of magnets. A more common definition, “counteract” or “a force or influence that makes an opposing force ineffective or less effective,” (Merriam Webster) describes the effect of the raised subarray in relation to the remaining magnets in the lower bed below—by raising the offset subarray and the levitated array sufficiently above the lower bed, the levitated array escapes attractive forces from the base bed of magnets, so that the repulsive force of the offset sub array need no longer compete with those opposing attractive forces.

Moving actuated magnets can also cause the container to follow one or another fork in the path. Actuated magnets can stabilize the container, making rails less important or unnecessary. Raising a small subarray of magnets underneath the levitated array on the cargo container also provides more lift per unit area. Sensors in the lower and/or upper arrays or located elsewhere indicate the position of the load, as well as pertinent information like velocity, acceleration, roll, pitch, yaw and levelness. An active feedback scheme can then be employed in which the sensors measure the position of the levitated array, and the actuated magnets adjust to provide stabilizing forces to keep the load in a desired state. In this way, the system does not suffer from the insurmountable instabilities predicted by Earnshaw's theorem, which only applies to passive levitated systems.

Electromagnets can be used instead of or in addition to actuated permanent magnets, to levitate, accelerate, decelerate, rotate and stabilize the load. A combination of electromagnetic coils with actuated permanent magnets can provide more lift and faster and more fine-tuned changes in magnetic force than actuated magnets alone.

Expanding beyond a preset path, actuated magnets in a large planar array or bed can allow a load to be levitated and pushed or otherwise moved anywhere on the plane. A combination of one or more of sensors, AI, user input, and communication between the levitated array attached to the cargo container and the underlying bed of magnets allow actuated subarrays of magnets to raise up and support the cargo container via magnetic repulsion in the right spot, underneath the levitated array on the container. Electromagnets can be added to the underlying planar bed of actuated permanent magnets, to boost lift, reaction time and speed. Rails would not be used with the plane, except optionally at the outer edges.

In systems that require a user to push the load, or where humans or other vehicles travel, a false floor above the highest offset level of the base magnetic array is indicated to prevent the user or other vehicles from stepping on or running over moving or powered magnets.

Instead of a huge bed of actuated magnets covering an entire shop floor, moveable decks covered with actuated magnets can rearrange themselves repeatedly so that a load can be levitated and moved across the stationary decks, from origin to destination.

This disclosure further describes an apparatus for exercise and gaming, like a treadmill, which supports a person staying still, balancing, walking or running in one place with magnetic levitation. In contrast to existing direct drive treadmills which are limited by friction and inertia of a large conveyor belt, the levitated system controls are individually actuated magnets, each having very little mass and hence small inertia. Also, the levitated platforms are individually controlled, and have low mass. This allows for much faster response to changes in the user's running motion.

This disclosure further describes multiple configurations of a moving walkway like that familiar to airport travelers, which carries stationary and walking people on levitated platforms rather than conveyer belts.

This disclosure further describes apparatuses for power transfer, where actuated magnets cause a generator shaft to spin, producing power which could be used to charge a battery or run a machine, for example. Actuated magnets can similarly cause an oscillating, reciprocating or back and forth motion, which can directly generate power, or which in turn can be translated into a spinning motion of a generator's shaft to produce power, or which can directly power an axle, belt or other machine part.

### BRIEF DESCRIPTION OF THE DRAWINGS

FIG. 1 is an isometric view of a no-offset embodiment of a transport system for cargo—a base path of magnets, a cargo container levitated above, and rails keeping the cargo container centered above the path.

FIG. 2 is a front view of the no-offset embodiment of the transport system of cargo of FIG. 1, showing the cargo container with magnets attached underneath, levitating above the base magnet path, and rails keeping the cargo container centered.

FIG. 3 is an isometric view of a parallel path no-offset embodiment of a transport system for cargo—showing the same elements as FIG. 1, with a different configuration of base and levitated magnets.

FIG. 4 is a front view of the parallel path no-offset embodiment of the transport system for cargo shown in FIG. 3.

FIG. 5 is an isometric view of a bed of actuated magnets, with a 2×2 subarray of actuated magnets shown offset above the rest of the bed.

FIG. 6 is an isometric view of the same bed of actuated magnets shown in FIG. 5, with a 3×3 subarray of actuated magnets minus the center magnet shown offset above the rest of the bed, levitating a platform which has a matching array of magnets attached to its underside.

FIG. 7 is a sectional view from the side of FIG. 6, showing the bed of magnets with some magnets actuated, and the levitated platform with magnets attached underneath.

FIG. 8 shows several examples of arrangements of magnets which work well as levitated arrays, and which may be attached to the underside of a levitated object.

FIG. 9 shows an arrangement of magnets with both repulsive and attractive forces, to be used as a levitated array, and which may be attached to the underside of a levitated object. The arrangement includes an outer perimeter square of magnets exhibiting repulsive magnetic force, and an inner square of magnets exhibiting attractive magnetic force.

FIG. 10A shows a transport system wherein underlying actuated magnets raise up from a bed of magnets to support and stabilize a cargo container as it moves across the plane in any direction. A false floor is situated between the bed of magnets and the cargo container.

FIG. 10B is a sectional view from the side of FIG. 10A, showing the bed of magnets with some magnets actuated, the false floor, and the levitated cargo container.

FIG. 11 is an isometric view of a transport system consisting of multiple moveable decks, each of which is covered with an array of actuated magnets which can levitate cargo like the transport system shown in FIGS. 5, 6 and 7.

FIG. 12A is an isometric view of a treadmill, showing a person walking on levitated platforms in a walking area, and the remainder of the treadmill covered by an upper false floor.

FIG. 12B is an isometric view of the treadmill shown in FIG. 12A, with both the upper and lower false floors removed, revealing the bed of actuated magnets as well as levitated platforms which are travelling in the non-walking area.

FIG. 12C is a side cutaway view of the treadmill shown in FIGS. 12A and 12B, showing the bed of magnets with some actuated so as to lift the levitated platforms; the lower false floor covering the bed of magnets; several levitated platforms in the walking area and two levitated platforms in the non-walking area, the upper false floor covering the non-walking area, and the walking person.

FIG. 13A is an isometric view of a wireless power transfer system, wherein an actuated magnet is pushing an upper magnet up, which in turn acts on a generator, engine or machine through a shaft and piston connection, or by causing oscillating magnetic flux through a coil.

FIG. 13B is an isometric view of a wireless power transfer system, wherein a set of actuated magnets is exerting horizontal forces on a set of upper magnets, creating a torque so that the upper magnets spin the shaft to which they are connected. The spinning shaft in turn acts on a generator, engine or machine.

FIG. 14 is a side cutaway view of a planar mover with an underlying bed of actuated magnets that provide lift and horizontal and stabilizing forces to a levitated platform, as well as an overhead set of actuated magnets that provide further horizontal and stabilizing forces to a levitated platform. The levitated platform is attached to a horizontal shaft.

### DETAILED DESCRIPTION OF THE INVENTION

The systems described in this disclosure overcome each of the three previously described problems to realize a system of levitation capable of supporting weights up to a few hundred pounds or more on a levitated platform with lateral dimensions of up to several feet or greater.

Problem 1: Earnshaw's Theorem

In 1842 the British mathematician Samuel Earnshaw demonstrated a mathematical proof showing that it is not possible to stably levitate a collection of point charges in equilibrium solely by the electrostatic interaction of the charges. This implies that any configuration of magnets in a levitation application must be dynamically controlled. In many applications this dynamic control is achieved using electromagnets (e.g. levitated globes). For instance, a permanent magnet can be levitated over an array of electromagnetic coils which is tied to a feedback servo. The feedback is such that the currents in the electromagnet are adjusted dynamically to ensure that the permanent magnet remains in a stable stationary position. Since this method uses active feedback, it is not a violation of Earnshaw's theorem.

However, this arrangement is not well suited to levitation of objects weighing several hundred pounds given the power requirements. We estimate that such a system would require greater than 10 kW to support a one square foot area weighing 300 pounds. To overcome this power requirement, this invention uses permanent magnets to provide the levitation force. To make the levitation stable, the magnets are dynamically controlled in the vertical direction. As an example of dynamically controlled levitation using only permanent magnets, arrange two magnets of equal size such that one magnet is fixed and the other levitates above it at a certain distance. Four smaller magnets are attached to linear servos on each lateral side of the levitated magnet. As the servo is moved up and down, it creates a horizontal force which repels the magnet horizontally. By tying the servo to a position-sensing feedback system, the levitated magnet is held in a stable position. Since the levitation force is provided by the permanent magnets, this system uses little power as compared to a system which uses an electromagnet to provide the levitation force. The only power consumed is in providing the active feedback.

Problem 2: Poor Scaling

There is a limit to how much weight can be supported in a levitation application for a given magnet size. In general, to levitate more weight requires more magnetic material. However, for a given magnet thickness, the levitation force per unit area does not scale with surface area as the magnet is made larger in the lateral dimensions. To demonstrate this lack of scaling, we simulated two N52 Neodymium magnets each 0.25 inches thick and separated by a levitation gap. We varied the levitation gap and the lateral size of the magnets, while keeping the thickness fixed. The results show that the force per unit area decreases as the width of the magnets increases.

For an application where a large amount of weight (hundreds of pounds) must be levitated on a large platform (feet scale in lateral dimensions) this lack of scaling is a problem. If the solid magnetic plates are replaced by an array of smaller submagnets with spacing in between each submagnet, the lift force is increased significantly. When comparing the amount of weight that can be levitated by a 1 ft square solid plate N52 Neodymium magnet as opposed to a 1 ft×1 ft array of 0.25 in thick N52 Neodymium magnets with ⅛ inch spacing between the magnets, at a levitation gap of 0.5 cm, the lifting force of the array is 50% more than that of the solid plate. In this disclosure, we utilize arrays of spaced magnets in the levitation scheme to increase the levitation force.

Problem 3: Small Magnet Over Larger Magnet

It seems logical and practical to try to levitate a relatively small magnet array over a much larger array. We discovered, however, that the levitation force on a magnetic platform of constant size decreases as the size of the lower array of magnets is increased. Our simulation and testing consistently show that as the lateral size of a lower array of magnets increases, the levitation force per unit area imparted to a levitated magnetic array of fixed size decreases.

We simulated and experimented with lifting and offsetting the subarray of magnets directly under a levitated array of magnets, from the main base array. We found that as the offset distance (vertical distance between base magnets which remain at the base level and base magnets which have been offset and lifted up) increases, the levitation force also increases, to a point.

We simulated and tested three scenarios: 1) No Offset—the lower array is a 10×10 array of magnets and all the magnets in the lower array are in the same plane. 2) With Offset—the lower array is a 10×10 array of magnets but the 2×2 set of magnets located directly under the levitated magnets are offset vertically above the rest of the 10×10 plane by 4 cm. 3) Small Lower Array—the lower array of magnets has the same size and spacing as the 2×2 magnet upper array.

Test data closely tracked our calculated simulations. We found that when a small 2×2 array is levitated over a larger 10×10 array (No Offset group) relatively little levitation force is provided as compared to the case when both levitated and lower arrays were the same size (Small Lower Array group.) However, when a subgroup of the magnets in the larger 10×10 array directly underneath the levitated array is offset vertically above the rest of the 10×10 array by 4 cm (With Offset group) the levitation force is restored to the level of the Small Lower Array group.

To provide context, in the No Offset test, the lower 10×10 array could not lift or levitate the upper array structure, weighing about 6 pounds, at all. Both the With Offset and Small Lower Array tests were able to levitate over 20 pounds. This concept of using an offset magnet subarray to increase the levitation forces from a large lower array is central to this invention.

We believe that this phenomenon is due to attractive forces between base magnets which are not directly under the levitated array magnets, and the levitated array magnets. We observe the maximum lift force of a given lower array to be reached when the lower array is far away from any other base magnets. We have found that when using magnets which are between ¼ inch and 2 inches thick, then an offset magnet subarray reaches its maximum amount of lift provided to a levitated array when the offset subarray is raised 4 centimeters above the rest of the base array. We found that, for these magnet thicknesses, and with a target levitation gap of 0.25 cm (the gap between the offset subarray magnets and magnets in the levitated array) in order for the offset subarray to provide at least 50% of its maximum lift force to the levitated array, the offset should be at least 0.25 centimeters, which along with 0.25 cm levitation gap creates a target gap of 0.5 cm between the levitated array and the base magnets not levitated, thereby sufficiently escaping attractive interactions with the base magnets to allow a lift force that is 50% of its maximum.

We next describe a simplified no-offset embodiment of a transport system for cargo (cargo herein meaning a mass or quantity of something taken up and carried, conveyed or transported, as defined by Merriam Webster), which overcomes the problems of Earnshaw's Theorem, poor scaling and small magnet over large magnet. A 2×2 magnet array is levitated over a long chain of fixed permanent magnets. This configuration could be useful in applications where lateral motion in only one dimension is needed. Simulations show that, similar to the case of a small array over a large square array, the force per unit area decreases as the base array is made large (longer in this case). However, the falloff with increased length in one dimension is less severe than in the case where the base array grows in both length and width.

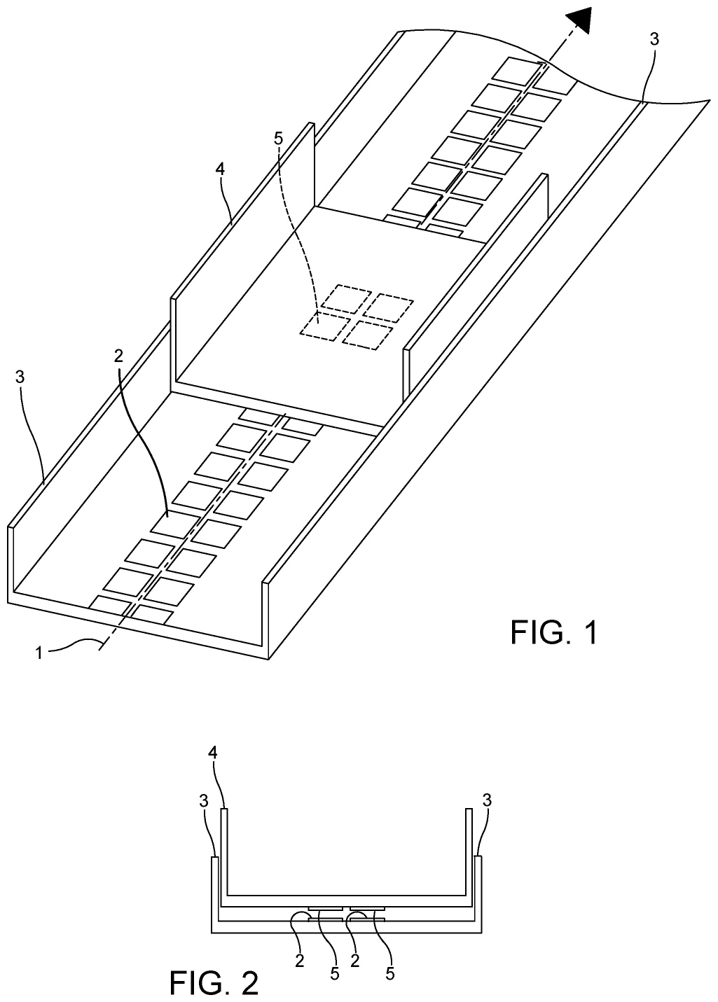

This no-offset embodiment, shown in FIGS. 1 and 2, includes a long narrow permanent magnet array (1) arranged as a level path, for example 2 magnets across and 100 magnets long, which are all attached to the floor. All of the magnets (2) in the lower array are of the same size (for example 1 inch square and ¼ inch thick) and strength (for example N52 neodymium.) The top and bottom surfaces of each magnet (2) are square shaped, and the height of each magnet is small. Each magnet is spaced ⅛ or ¼ inch away from its nearest neighbors. Each magnet (2) in the base path array (1) has a polarity pointing in the same direction up. Physical rails (3) stand parallel to the base path (1), on both sides of the base path, equidistant from the center of the base path (assuming the cargo's center of gravity is in the physical center of the cargo.) The height of the rails (3) and distance between the rails are chosen according to the size and shape of the intended cargo to be moved along the path. The purpose of the rails is to keep the cargo and cargo container (4) from slipping off the path on either side. The rails are physical restraints which help overcome the instability described in Earnshaw's theorem.

In this simplest no-offset embodiment, only one size of cargo or cargo container is used with the transport system. A cargo container (4) has an array of magnets (5) composed of magnets of the same size, shape, type and strength as a subset of the magnets (2) in the lower array. This upper levitated array is attached to the underside of the cargo container (4), as shown in FIG. 2, with all of its magnets (5) having a polarity pointing down with the same polarity as the lower array magnets (2) point up, such that the upper levitated array repels the lower path array (1). The levitated array has the same width as the width of the base path array (1), and the levitated array (5) is centered on the underside of the cargo container (4), for balance and stability.

When the cargo container (4) is placed above the path array (1), the cargo container (4) levitates due to the repulsion between the levitated and base path magnet arrays. The rails (3) prevent the cargo container (4) from moving from side to side, so that the levitated array (5) is always precisely above some portion of the base path array (1). A user can push the cargo container (4) from behind, or pull from the front, walking over the base path array (1), causing the cargo container (4) to easily move along the path between the rails (3).

This simplest no-offset embodiment takes advantage of the increased levitation force of a narrow base array, which is limited in one horizontal dimension, as opposed to a large base array, which is not limited in either dimension. As shown in our research, a lower planar array with large width and length relative to the upper array does not provide much, if any, overall levitation force. Simulation suggests that this is due to the attractive forces between each levitated magnet and adjacent magnets in the base array. The interaction between a lower magnet and a levitated magnet that is directly above is purely repulsive. However, when a levitated magnet is laterally displaced between 82% and 100% of its width from a lower magnet, the interaction becomes attractive (exact numbers for this transition depend upon the thickness of each magnet.)

If we consider a single levitated magnet over a two dimensional array of lower magnets, we can use the single magnet simulations to predict the net force on the levitated magnet. Considering the 3×3 planar array of lower magnets underneath and closest to the levitated magnet, one lower array magnet is strongly repelling while 8 nearest neighbors below and around the levitated magnet are attracting. By contrast, a linear array has fewer attractive nearest neighbors. For example, a single levitated magnet over a 1 magnet wide base array has only two attractive nearest neighbors in the base array.

Limiting one dimension of the base array, as in the no-offset embodiment for cargo transport, allows the base path array to exhibit a substantial amount of levitation force per unit area, although it still has a smaller levitation force per unit area than a series of small actuated offset subarrays would exhibit on an upper levitated array.

A cargo container (with or without cargo) could also traverse the base path without human intervention. Any means of propelling the levitated cargo container along the path from origin to destination is incorporated as part of this invention, including mechanical (such as single or multiple wheels, or arms in constant or temporary contact with the lower array top surface or rails), forced air such as with an onboard fan, compressed air or pressurized gas emission, atmospheric airflow imparting force to onboard sails, or a small robot “tug” either pushing or pulling the levitated cargo. These “tug” robots could also attach to the cargo containers on one or more sides to provide stabilizing forces, in addition to forces to impart motion.

The individual magnets in the upper and lower arrays may be a different size or shape than that described in the simple no-offset embodiment, for example the shape of the top- or bottom-facing side of each individual magnet may be square or rectangular (as in a rectangular prism), or circular (as in a cylinder), or some other shape. Each individual magnet may be a sphere. The magnets may be arranged in a regular pattern which is not exactly the same as the described square, rectangular or linear arrays. The magnets in the upper array may not be exactly the same in size or strength as those in the lower array, and may not have the same lateral spacing between magnets. In this case, force curves for any particular magnet size may be calculated and used to predict the forces and find an optimal arrangement that provides maximum levitation. The size and shape of the cargo container may vary, so long as its lateral movement is constrained between the rails, and its load can be distributed so that it properly balances while supported by the repulsive magnetic force applied to the magnetic array attached to the cargo container's underside.

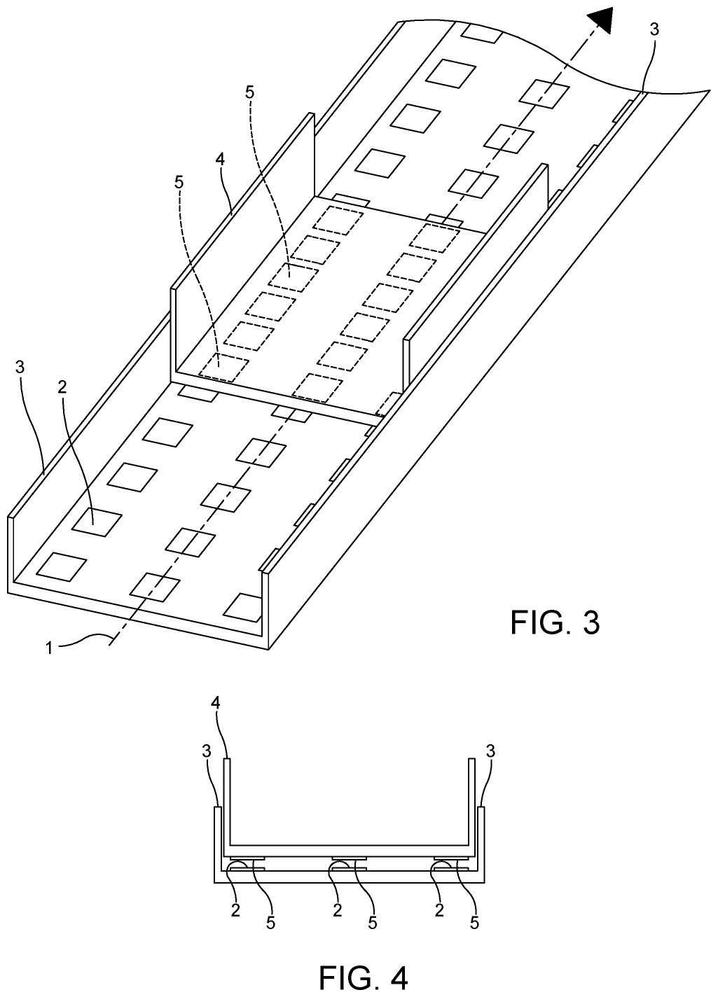

To increase the overall levitation forces applied to a levitated cargo container, as shown in FIGS. 3 and 4, the no-offset embodiment could be composed of multiple linear lower arrays, each parallel to the others, with each linear lower array (1) separated by a lateral spacing to reduce attractive forces of nearest neighbors. Hundreds or thousands of pounds in each cargo container (4) can be moved with a system like this. The lateral spacing size is optimized for the particular magnet size and thickness. For square magnets 0.85 inch wide and 0.25 inch thick, substantially reduced attractive forces of approximately 25% of peak attractive forces occur when magnets in the lower array have lateral spacing between them of 50% of magnet width, as compared to a maximum attractive force at a lateral spacing of approximately 5% of magnet width. To achieve optimum levitation force for a given mover area, the magnets (2) within each no-offset linear base path would be placed as close together as practical, while the distance between each of the linear base paths would be at approximately 50% of the width of the magnets used in the linear base path. Note that FIGS. 3 and 4 show multiple base paths (1) which are further apart than this exemplary optimal configuration.

In this no-offset multiple parallel path embodiment, the levitated cargo container (4) could have multiple long, linear upper arrays of magnets (5) as shown in FIG. 3, each of which would levitate above a long, linear lower array. Rails (3) along the outer edge lower arrays constrain the cargo container (4).

In an alternative no-offset multiple parallel path embodiment, the configuration consists of lower array paths one magnet wide and upper arrays only one magnet wide. Multiple one-magnet-wide lower arrays separated by, as an example, lateral spacing the width of one magnet, could be combined to increase the levitation force on a cargo container consisting of multiple upper arrays one magnet wide of varying lengths, with each row of upper array magnets also separated by a lateral spacing the width of one magnet.

We have found that lateral spacing between nearest neighbor magnets cause the levitation force to vary as levitated magnets move over the lower magnets and gaps between the magnets, causing a bumpy ride. This makes intuitive sense, because the repulsive force is greatest when a levitated magnet is directly over a lower magnet, and is least when a levitated magnet is directly over a space between lower magnets. We have found that the force varies more considerably as the levitation gap is reduced, and the force varies as much as 25% as the levitated magnet is moved over the static array, so that in an application where a load is being manually pushed over this non-actuated lower array, the user will need to overcome the natural tendency of the load to sit at the minimum of the force curve.

There are multiple approaches to overcome this force variation (bumpy ride) of a narrow upper array over a narrow lower array. In one approach, multiple narrow arrays (one or two magnets wide each) running the length of the path would each be separated by lateral spacing that reduces the attractive forces of magnets from the adjacent narrow array. Then, each of the narrow lower arrays is slightly offset in the Y dimension (the length of the path) from magnets in the adjacent narrow lower arrays. By offsetting each of the narrow lower arrays, when a levitated platform consisting of multiple narrow upper arrays with each of the upper arrays aligned along both the x and y dimensions, the average vertical levitation force applied to the levitated platform is smoothed as it is moved on the Y axis over the narrow lower arrays.

Another approach to reduce the vertical force variation (bumpy ride) on a levitated platform is to use stronger magnets (for example thicker magnets) on both the upper and lower arrays. Maintaining larger levitation gaps reduces the variation in levitation forces as upper array magnets are shifted over lower array magnets. Therefore, for a given load, using stronger magnets increases the levitation gap, and thereby reduces the force variation as the levitated array is moved over the lower array, providing smoother motion.

Without adding any complexity to the magnetic lifting system itself, these no-offset embodiments can have paths of magnets with curves, as well as forks where the user chooses to push the cargo container one way or the other. Rails would continue to be necessary to keep the cargo container, including the magnetic array attached to its underside, centered over the path.

The no-offset embodiments can be made dramatically more powerful, and able to lift heavier loads, by adding linear actuators to the magnets in the path, which raise and lower the magnets individually. As the user pushes the load along the path, actuated magnets from the base path, underneath the levitated array attached to the underside of the cargo container, raise up to support the load. The linear actuators are dynamically adjusted so that a subset of the magnets from the base path are raised or offset a sufficient height, so that both the raised offset array and the levitated array escape the attractive forces of the remainder of the magnets in the bed. The linear actuators on the underlying magnets can be controlled based on one or more of user input, sensors on the path, sensors on the cargo container, video monitoring, communication between the path and the cargo container, and other methods. In this implementation, a non-magnetic floor (i.e. false floor) may be installed, just above the highest intended position of the actuated magnets, to prevent the user from stepping directly on the moving magnets and sensors, and damaging them, or tripping. Other methods of preventing the user (or other machines or objects) from stepping directly on or making contact with the magnets in the path may be developed.

When a false floor is used, the levitation forces from offset subarrays can be used to lift levitated objects just enough so that they can slide easily across the false floor. A low friction interface between the floor and the levitated object is indicated—such as a slippery floor, or ball bearings attached underneath the levitated object. This reduction of friction, short of actual levitation with an air gap between the levitated object and the floor, may provide enough value for some applications, where actual floating levitation may not be necessary. For some applications, the combination of a low friction interface and horizontal forces imparted from offset subarrays to upper arrays on an object will be enough to move the object across the floor.

Although many varieties of linear actuators are available, generally the types can be separated into four categories: electro-mechanical, hydraulic, pneumatic, and piezoelectric. While actuators in each of these categories have benefits, the choice of linear actuators must be determined by attributes including, but not limited to, range of motion, speed, accuracy, strength, size, self-containment, maintenance level, and cost efficiency. The actuators must have a large enough range of motion to exert the necessary forces and torques on the levitated array for a particular application. For instance, in an application where lift forces are critical, we found 4 cm to be a good minimum displacement. In a different application, where speed is more critical, a smaller actuation range could be ideal. We have found that in exemplary configurations, 0.25 cm actuated lift allows an offset array to provide 50% of its maximum repulsion lift force to a levitated array at a levitation gap of 0.25 cm. Therefore, a reasonable minimum range of motion for an actuator is 0.25 cm for many applications. Actuation speed must be high enough to be able to adjust with respect to real-time active feedback. The actuators' adjustment must have continuous precision along the range of actuation. The actuators must be small enough to satisfy the size constraints of the application, and self-contained to maintain a simplicity to the mechanism of actuation. Additionally, maintenance level and cost efficiency are to be considered. We have found that micro electro-mechanical linear actuators best satisfy the above constraints. For a running treadmill application, we expect an actuation distance of 4 cm over a 300 ms time span (requiring speeds of 13 cm/s).

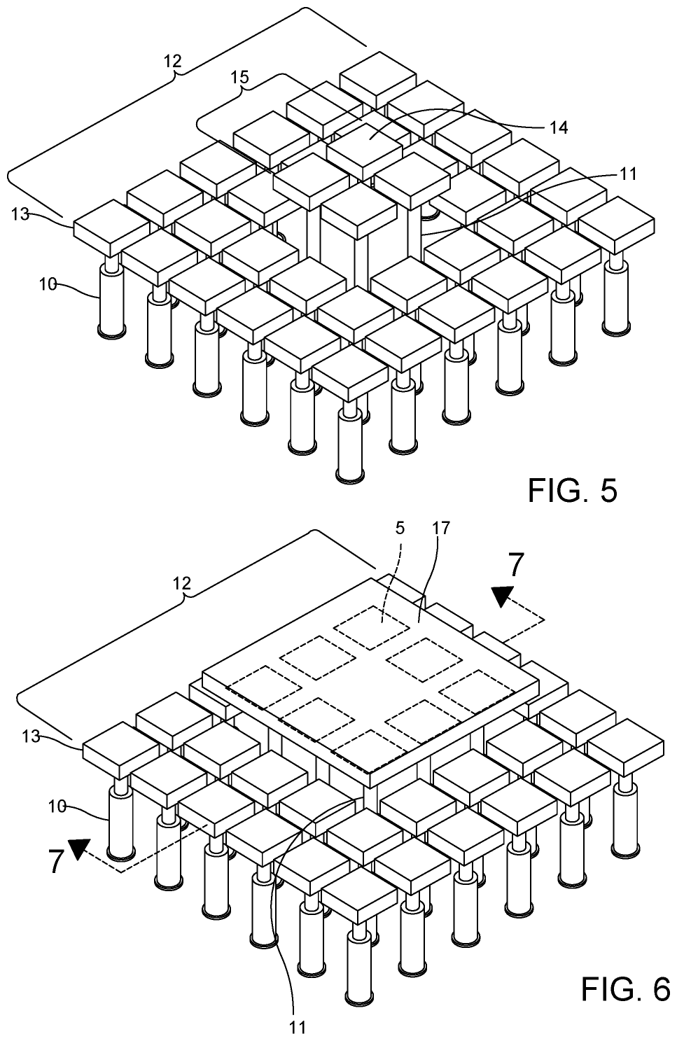

Actuators used to move magnets to an offset position may take a myriad of forms, including those shown in FIGS. 5, 6 and 7 as (10), which move in a telescoping fashion. Other embodiments of actuators include but are not limited to a spiral track, where twisting the actuator one way causes the magnet to rise, and twisting the other way causes the magnet to lower; and a rotating disk or cylinder with a horizontal axis and a magnet mounted on the curved face, such that the magnet is in the offset position when the cylinder rotates the magnet to the highest point.

The lifting of the offset magnets can be accomplished in any number of ways, and the description of the use of a linear actuator is not meant to limit the invention to just the use of linear actuators to lift the offset magnets. As further examples, the offset magnets can be lifted by electromagnets, constructed such that beneath the lower array of magnets exists an array of electromagnets. To isolate the effect of the electromagnet on the lower array magnet, rather than the electromagnet acting directly on the lower array magnet to raise it to the offset position, it instead acts on a second magnet attached to the lower array magnet, and positioned between the electromagnet and the lower array magnet. Each of the magnets within the lower array is attached to another magnet that is between the magnet and the lower electromagnet, creating a 2-magnet vertical system. As the electromagnet is turned on, it repels the 2-magnet system upward, in an actuating motion. The raised 2-magnet system becomes part of the offset array, and is locked in place, as by for example a mechanical gear. The mechanical gear is then used to dynamically adjust the offset magnet's vertical height as needed. A similar approach can be accomplished by a push/pull solenoid system, such that the lower array magnet can be positioned at the top of each solenoid, and when the solenoid is activated, the lower array magnet is moved into the offset array. More generally, the offset magnets may be lifted by any means, so long as the offset magnets are raised, and can then be dynamically adjusted in offset height above the base array, to enable control and movement of the levitated array.

Linear actuators require power to move upwards. When the actuator must lift extra mass, more power is needed. However, once an actuator has reached a given position, it can stay in that position indefinitely without requiring any more power. A set of lifted magnets could provide repulsive magnetic force continuously on a load, without using any power at all. This feature makes a huge difference as compared with using electromagnets for lift, which must continuously use power to create any magnetic field.

Power Comparison: There are two scenarios with which we can compare the power needed for levitation of the offset permanent magnet based actuated system and the traditional electromagnetically based system: static loads and dynamic loads. In the static load case, the offset permanent magnet based actuated system (neglecting the power needed for active feedback) requires no power. By contrast, the electromagnetic based system requires that power be constantly supplied to the coils in order to generate a magnetic field to levitate a static load.

We have described four concepts:
1) Dynamically adjusting the vertical position of magnets (e.g. with linear actuators) in an active feedback scheme to overcome Earnshaw's theorem for stable magnetic levitation.
2) The use of an array of relatively thin magnets with spacing between them for increased levitation force as compared to a solid magnetic plate.
3) Levitation of a small magnetic array over a large array of magnets in which some of the magnets in the large array are offset vertically.
4) The ability to move the levitated array laterally across the large lower array by dynamically raising and lowering the subset magnets individually into a series of offset arrays.

In the no-offset path embodiments already described, stability of the load has been provided by the use of rails on both sides of the path. The rails and the path limit where the loads can originate and end up, and non-adjustable rails limit the size and shape of the cargo which can be transported. One way to increase versatility of the system is to use the same idea of raising small offset arrays, but with a larger planar lower bed of magnets, covering a larger portion of the footprint of a warehouse floor, for example, where length and width of the lower array is not as limited. Rails would not be compatible with such an implementation, except perhaps on the edges, to make absolutely sure a load doesn't fall off the edge.

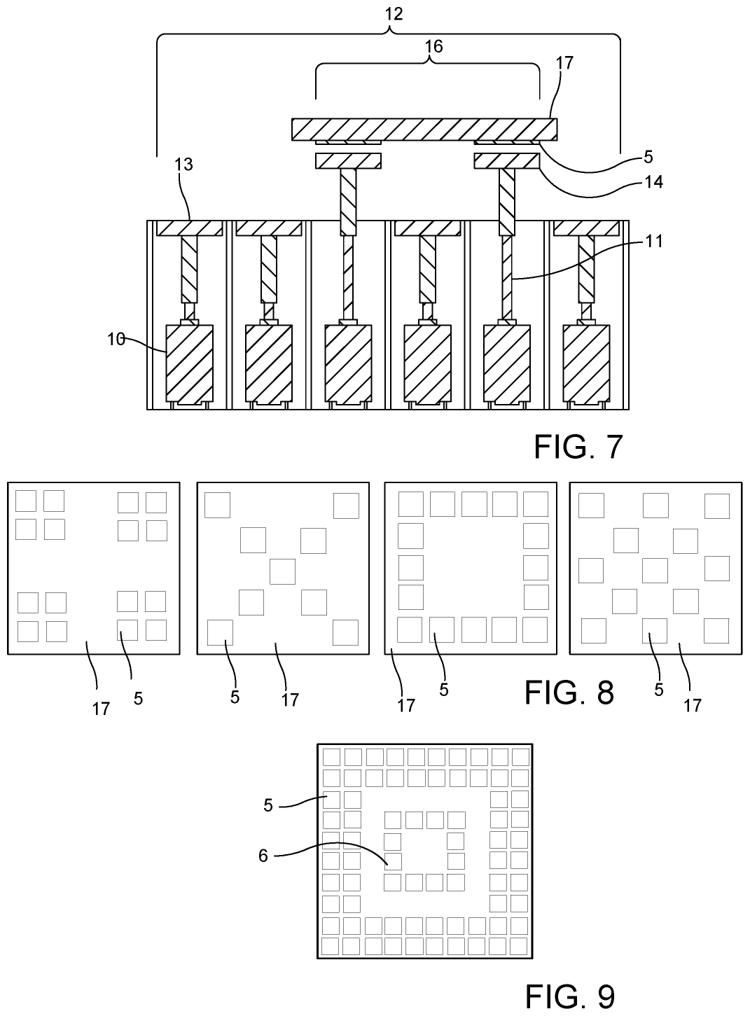

We combine these elements to realize a system concept as shown in FIGS. 5, 6 and 7. The figures shows a bed (12) of magnets (13) connected to linear actuators (10, 11) which move up and down vertically. Above the bed (12) of actuated magnets (13) is another smaller magnetically levitated array (16) of magnets (5) which is attached to a levitated object or platform (17) (shown in FIGS. 6 and 7, not in FIG. 5.) By selectively moving the actuated magnets (14) up and down in subarrays (15) sized similarly to the levitated array, an offset subarray (15) is maintained directly underneath the levitated array (16) as much as possible, and this actuation can serve both to stabilize the levitation and to move the levitated array (16) and object/platform (17) laterally.

In an exemplary embodiment, all magnets used are 1×1 inch square, ¼ inch thick N52 neodymium magnets, spaced ¼ inch apart. The bed consists of a 10×10 square matrix of these magnets, each of which is connected to a vertical actuator that can lift each individual magnet 4 cm above the plane of the lowest array, and each of which is oriented with N facing up. The upper array consists of a 2×2 square matrix of these magnets, permanently attached to a platform or object, with all magnets oriented with N facing down towards the lowest array.

In a demonstration of this embodiment, the repulsive force generated by the permanent magnets lifted 20-25 pounds 1 cm, and lifted 5 pounds almost 3 cm.

Many variants to this example embodiment would provide enough levitation to lift a person. Each levitated array or arrangement of magnets may be in a rectangular or square pattern, or a hexagonal pattern, or a pattern of segments of concentric circles, or another regular pattern where the magnets may be spaced regularly. The array may be full of magnets, or some of the center or inner magnets may be removed.

We have found through experimentation and simulation that the offset and levitated arrays do not need to be filled; instead, magnets can be removed from the center area of the levitated array, and not lifted for the offset array. A center-removed type of configuration as shown in FIG. 6 provides a comparable amount of lift as when using a completely filled type of configuration, probably at least partly because the levitated array has fewer magnets and therefore less mass. This array configuration opens up possibilities of systems using fewer magnets in the levitated array than a full array, with lower cost and lighter weight, while having nearly the same amount of lift force.

The magnets in each levitated array must not be too tightly packed; on the contrary, there must be some amount of space separating each magnet from its neighbors. For example, the sides of square magnets ideally should not touch each other, and our simulations and testing teach that the spacing should also be less than the magnet width. The simplest embodiment includes a square matrix of square magnets, where there is a small space between every magnet and its neighbors. Alternatively, a corner of a square magnet may touch the corner or the side of another square magnet, since such a configuration leaves plenty of space around each magnet. Similarly, cylindrical and spherical magnets may touch each other, since even the most tightly packed configuration of circles only contact each other at several points on each circumference, and sufficient empty space remains around each individual magnet. Hexagonal magnets configured in a hexagonal array can pack too tightly, and so like a square matrix, would need a small space on every side between each magnet and its neighbors, with no magnets touching each other to achieve maximum levitation force. Magnets in the levitated array may be far apart from each other.

The actuated magnets in the bed can be very close together so long as they don't interfere with each others' actuation, and should have interspacing that does not exceed the smallest lateral dimension of the bed magnets.

In another embodiment, multiple 2×2 arrays (square matrices) of magnets are mounted to the underside of a non-magnetic platform. The 2×2 arrays are not adjacent to each other, so that as an example, the width of one array separates each of the mounted 2×2 arrays. This platform, with multiple 2×2 arrays mounted to it, now rests over a lower array of magnets. At every spot where a 2×2 array is located on the platform, magnets are raised from the lower array such that an offset array exists underneath each 2×2 array, with each offset array contributing to the levitation force applied to the platform. We have found that this amount of spacing between the arrays is far enough to avoid undesired interactions, and provides enough room to allow for lateral control techniques for each of the levitated arrays.

The minimum or optimum offset gap, which is the vertical distance between the base array (12) of magnets (13) and an offset subarray (15) of magnets (14) which has been raised above the base array, such that sufficient, desired or optimum repulsive forces are created between the offset subarray and a levitated array, will vary. A minimum distance is necessary for the levitated array to escape the attractive influence of magnets in the larger base array. Variations in this minimum distance will depend on the size and strength of magnets in each array; desired lifting force; desired levitation gap; the size of the offset and levitated arrays, and other factors. However, we have found that regardless of size and shape, a minimum of 0.25 cm offset between base array and offset subarray with a levitation gap of 0.25 cm between offset subarray and levitated array is needed to reduce the attractive forces of the base array on the levitated array by 50%.

Desired levitation gap, which is the vertical distance between the subarray (15) of magnets (14) and the levitated array (16) of magnets (5), will vary based upon details of the application and amount desired to be lifted. Keep in mind that as levitation gap decreases, repulsive/lifting force increases. This can be useful, for example, when an object falls onto a levitated platform—the greater force of the object's impact pushes the levitated platform closer to the offset array, decreasing the levitation gap, but at the same time the lifting force increases, so the offset subarray and levitated array are less likely to collide. If the application of the technology includes a physical barrier between the offset subarray and the levitated array, then there would be a minimum levitation gap needed.

We studied the effect of magnet thickness on the weight that can be levitated as a function of levitation gap, and found that doubling the thickness of both the lifting (lower) magnet and the levitated (upper) magnet roughly doubles the levitation force, while doubling the thickness of just one of the magnets results in an approximately 50% increase in levitation force. This allows for a tradeoff between levitation force and system size and weight in a given application. This also allows for a larger levitation gap which lifts the same amount of weight.

The optimal array design, minimizing system cost and levitated platform weight, will depend on a multitude of application design goals and objectives. Variables to optimize may include offset gap and levitation gap, as previously discussed, as well as thickness, size and shape of magnets used in each array, size of arrays, spacing between magnets in each array, full array versus magnets removed from the center of an array versus other optimized shapes (examples shown in FIG. 8) and placement of levitated arrays within the application.

Lateral Movements

To levitate a motionless load, a set of magnets underneath the upper array attached to the underside of the load must be lifted sufficiently high above the rest of the lower bed of magnets so that the levitated array escapes the interference and attractive forces of the lowest, large bed of magnets. In an exemplary embodiment using N52 magnets which are ¼ inch thick, and 1 inch square, a vertical offset levitation gap of 4 centimeters was found to be sufficient to achieve maximum lift. If the load moves, then actuated magnets from the lower bed must raise themselves so as to create an appropriately sized offset subarray located as precisely underneath the load's array as possible. Actuated magnets which are already raised up, but no longer precisely underneath the load's levitated array, must lower back down to the lower bed level. As the levitated platform continues to move, different sections of the lower bed array are raised and lowered so that the offset subarray is always directly (as much as possible) underneath the levitated array.

In addition to providing the force needed for levitation, the ability to raise and lower different sections of the bed of magnets also provides a means of generating the horizontal forces needed to cause these lateral movements. By raising and lowering magnets near the edge of the levitated array, a horizontal force is created. Consider a 2×2 magnet array levitated over another 2×2 array. An additional set of two magnets is offset near the edge of the lower magnet array. As the additional two offset magnets are brought higher, a horizontal force is generated on the levitated magnets which in combination with gravity will cause the levitated magnets to move away laterally. By adjusting the height of the additional two magnets, the horizontal force on the levitated array can be adjusted. Not much force is needed to move the levitated array, since there is no friction to overcome except air resistance, and gravity is used to enhance the horizontal force. In another embodiment, magnets are lowered and raised near the edge of the levitated array, from the levitated array platform itself. Similar to raising and lowering magnets near the edge from the lower array, interactions between the upper and lower magnets create a horizontal force, which can cause lateral motion of the levitated array.

In another example, to cause a load to move to the right, one or more of the actuated magnets located just to the left of the current position of the load, and/or the leftmost actuated magnets currently supporting the load, move up a short distance. This force, combined with gravity and the absence of friction, effectively provides a nudge to the right. Another method to cause a load to move to the right involves one or more of the actuated magnets located just to the right of the current position of the load, and/or the rightmost actuated magnets currently supporting the load, to move down a short distance. This change in force acting on the load allows gravity, combined with the absence of friction, to tug the load to the right. Both of these methods can be used, or just one. At the same time, or a split second after the nudge and/or tug, actuated magnets to the right of the load must raise up to support the moving load.

To cause a load to stop, a series of one or more of the actuated magnets which are ahead of the load in its moving path must raise up to nudge the load backwards, causing it to sufficiently decelerate and stop.

Actuated magnets in and around the offset array can nudge the upper array with enough horizontal force to cause the upper array to move, speed up, slow down, rotate, change direction, and stop. When performing these functions, the lower magnets are additionally providing levitational force. The lower array of actuating magnets may also serve to provide adaptive control, helping to stabilize the upper array, by increasing and decreasing their height, thereby keeping the levitated platform stable.

Each offset magnet causes significant vertical and horizontal forces to act on levitated magnets above, the exact forces depending upon the levitated magnet's location relative to the lower offset magnet. By calculating and graphing force curves, we can perform a constrained optimization to determine actuator displacements needed to levitate a load and provide desired horizontal forces.

One set of actuations provides a constant levitation force as a small levitated array moves across a lower array. Another set of actuations serves to both levitate a load and apply a fixed horizontal force to move a small levitated array across the lower large array. Actuations can also use active feedback to stabilize the levitation. In an active feedback scheme, one or more position sensors are used to determine if the levitated platforms deviate from a desired location. The actuations are then adjusted to provide a horizontal force to move the platform right or left to maintain the desired position. The actuations can also be adjusted to provide a torque force to rotate the platform to maintain a desired orientation.

In another variation of the levitated array, magnets of the opposite polarity can be used to further stabilize the array and produce an attractive horizontal force. An appropriate configuration for magnets attached to the underside of a levitated platform is shown in FIG. 9, with repulsive magnets (5) placed around the perimeter of the platform, and attractive (opposite polarity) magnets (6) placed in the center of the platform. It is clear that lower magnets lifted near the upper opposite polarity magnets will produce an attractive horizontal force which can be used to move the array laterally.

The magnets raised and lowered near the exposed inner edge of the levitated array may be raised and lowered from the lower array, or lowered and raised from the levitated array platform itself. In either case, horizontal forces are generated which create lateral motion within the levitated array.

Electromagnets may be added to provide additional stability control and movement control. These electromagnets may be interspersed between or incorporated into the permanent magnets of the lower array, and turned on and off at different current intensities at will.

Electromagnets may replace all or some of the permanent magnets on the lower array. These electromagnets would not move up and down; instead they would turn on and off, each providing a similar amount of magnetic force as one offset permanent magnet. Each electromagnet could also be turned on at a lower current intensity, to simulate a partially raised offset permanent magnet, or a higher current intensity to provide more magnetic force.

Sensors are necessary to effectively perform feedback stability control. Different types of sensors, such as optical, Hall effect, ultrasonic, capacitive and inductive sensors, may be used to determine whether the levitated array is in the desired position, and whether it is stable. For example, a sensor on each actuated magnet may determine whether the levitated array is the proper distance away. In another example, sensors may be deployed on the levitated array, whether it be on the edges or in the middle of the array, to sense whether the levitated array is centered above the offset array. Depth sensors, microphones, and optical sensors such as visible light and IR cameras may be located anywhere on or outside of the system.

A levitation system for a factory and warehouse transport system, based on offset magnetic arrays

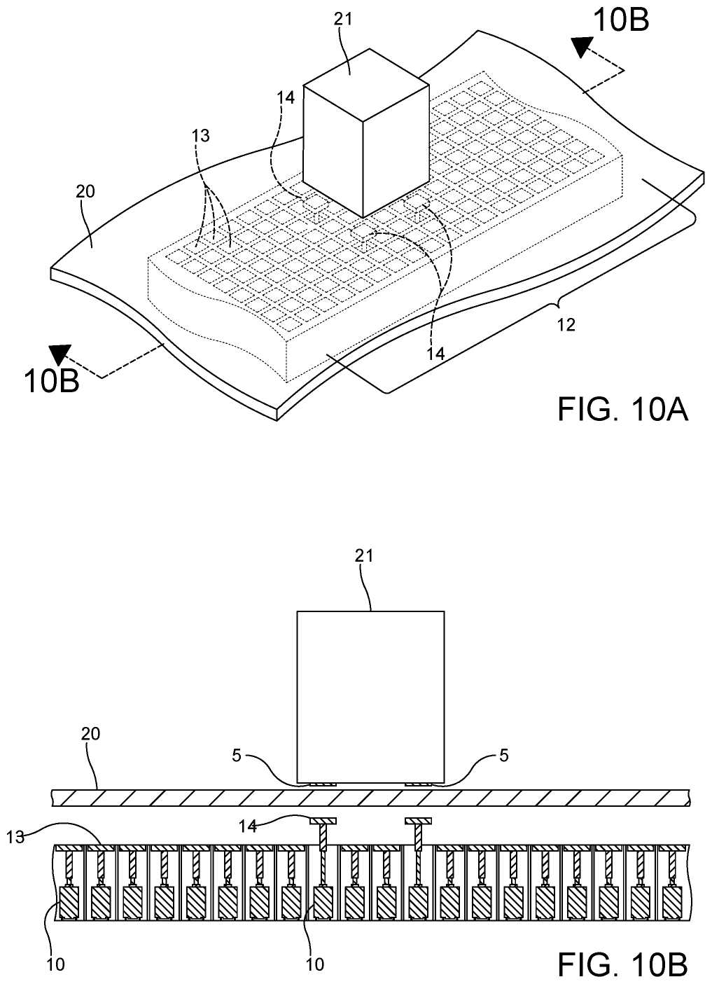

Utilizing the levitated platform system, and the means of moving the levitated platforms as previously described as a foundation, FIGS. 10A and 10B add a “false floor” (20) above the base magnetic array (12), and one or more offset subarrays of magnets (14). Above the false floor (20) are one or more levitated magnetic platforms/objects/cargo (21) with upper arrays of magnets (5) attached, which are levitated and adaptively controlled by the offset subarrays beneath the false floor. In a factory setting, adaptively controlling and moving the levitated cargo (21) via the offset magnet subarrays allows for transporting materials placed onto the levitated magnetic platforms from one location within the factory to another. Also, the levitated arrays of magnets (5) may be built into the structure that is used to transport materials from location to the next, such as a levitated storage bin, or the levitated magnetic platforms may be built into pieces of machinery that are moved from one location to the next, such as a toolbox, or a fan.

A user or some other external force could push a load across and above the floor, levitating above the actuated magnet bed. The underlying actuated magnets (14) raise up to create small dynamic offset subarrays underneath the levitated array on the cargo (21) as shown in FIGS. 5, 6, 7, 10A and 10B. Without physical restraints, however, the upper array's position is inherently unstable (see discussion of Earnshaw's theorem.) As discussed in our U.S. Patent Application 62/706,355, incorporated here by reference, sensors can be used to sense the position of the upper levitated array in relation to the offset subarray and the entire lower bed, as well as to sense the levitated array's velocity, acceleration and rotation. In response to this information, using an adaptive feedback process, magnets in and around the offset subarray raise and lower to provide forces which nudge and tug the levitated array into a position as close to precisely above the offset subarray as possible, keeping it stable.

Once an item of cargo (21) has been transported to its desired location, the offset subarray (15) need only be lowered to the base level, and the cargo is no longer levitated, and rests on the false floor (20). Although described above as a false floor, the floor may itself be suitably durable and structurally sound to allow normal foot traffic and mechanized factory equipment to traverse atop it.

Rather than requiring an external force to push and guide the levitated cargo, magnets in and around the offset subarray can nudge the levitated array underneath the cargo with more force, causing the levitated array and attached cargo to move, speed up, slow down, change direction, rotate and stop. When performing these functions, the offset subarray magnets are additionally providing levitational force and stabilizing the levitated array, all at the same time. Information from the same sensors used for stabilization can also be used to inform and instruct the actuated magnets how to move, in order to cause acceleration and deceleration of the levitated array and attached cargo container. A false floor may not be needed to cover the lower bed of magnets, if a user doesn't need to walk along with the cargo.

Many variations on this transport system can be imagined, such as systems ranging from having pre-set tracks and destinations, to systems allowing levitated objects to travel anywhere within the system. A robotic vacuum with a levitated array of magnets around its perimeter could clean a floor without touching or minimally touching the floor, and it could move with greater precision than one with wheels. More generally, any robotic system could be integrated with a levitated magnetic platform, thereby becoming a levitated object, and eliminating the need for wheels for transport.

These systems can be scaled to work in many environments, as on a countertop, moving or levitating in place houseware or electronic appliances to assist in daily activities such as cooking, where a recipe in a book or electronic device could be levitated and moved over a countertop without getting dirty. It can be used in a hospital, so that people typically on wheeled machines and beds are instead transported across the hospital on levitated machines, so they do not touch the floor and spread contamination as they travel from one location to the next. Movement of patients in their beds would be fast, effortless, smooth and quiet. Doctors and nurses could ride on levitated platforms (with function similar to today's segway) around a hospital, similarly avoiding touching the floor. The system can be used in a manufacturing or warehouse environment, to transport robotic systems from one task to the next.

Another method for achieving lateral forces in a large levitated array involves removing some of the magnets near the center of the array. As previously mentioned, the levitation force in this case is not severely reduced. We can use offset magnets near the exposed inner edge of this levitated array to produce a horizontal force, instead of or in addition to using offset magnets near the outer edge of the array to produce the horizontal force. A sizeable horizontal force is created as magnets are moved close to the inner edge of the levitated array.

The shape and size of the lower array may vary almost infinitely. It may be narrow and very long, or it may be a big circle, or a rectangle, or a zig-zagging track. The shape and size of the offset array and the upper array may also vary in shape and size.

The lower array need not be perfectly planar; it could have slopes and slides. The offset array and upper array may not be perfectly planar relative to the lower array, or relative to each other.

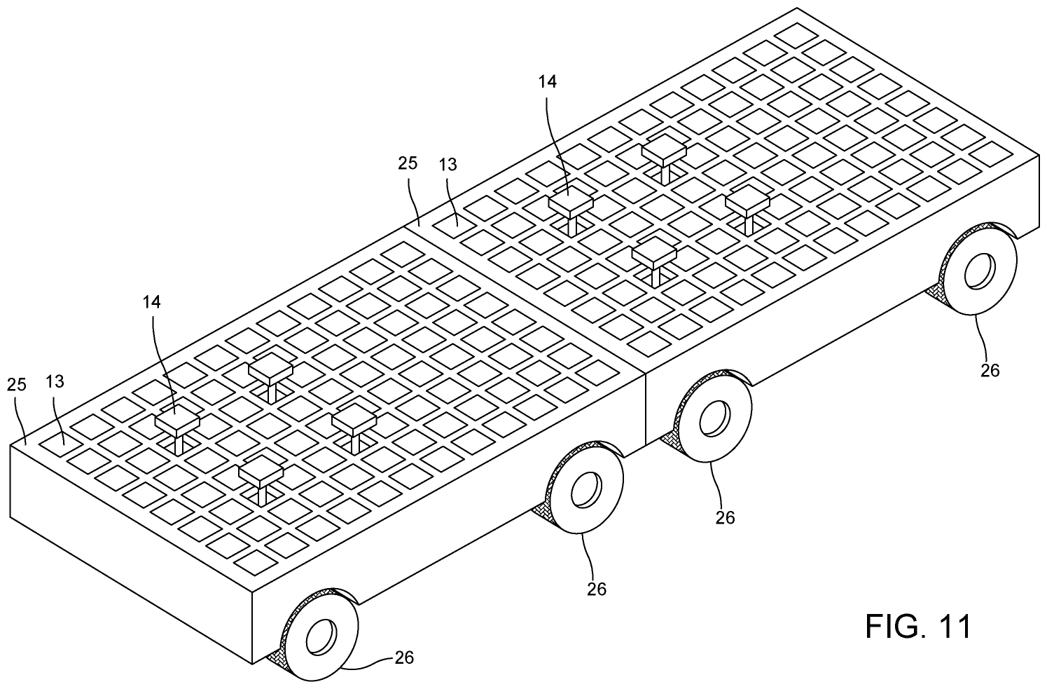

Moveable decks, as shown in FIG. 11, eliminate the need for the lower bed of magnets to be permanently stationary or permanently attached to a specific location; instead, the underlying lower array of actuated magnets is attached to one or more moveable decks (25) which can travel along the ground, making a stationary path for cargo—that is, stationary while the cargo is on top of a deck (25). The decks may move on wheels (26) or by some other means. Two or more decks work together in series and also possibly in parallel (as an example, 2 decks side by side underneath the cargo for a situation with 4 or more moveable decks) to underly and support the cargo container as the cargo container moves. Each deck has an array of actuated magnets (13, 14) covering its top surface. Before a cargo container moves onto a deck, the deck must set securely and immovably on the ground, for example by locking its wheels in place, extending stabilizers to lift its wheels, or by raising the wheels or lowering the deck so that the deck's frame touches the floor around the wheels. The deck also levels itself as much as possible. The user guides and pushes the cargo container across the unmoving, level deck as actuated offset magnetic arrays raise and lower themselves from the deck to levitate and stabilize the cargo container. An additional deck moves into place adjacent to the first deck, and sets itself before the cargo container moves on top of it. After the cargo container, and the user if the cargo is being guided by a user, moves off of the first deck, the first deck unsets itself, so that the deck can move to the next spot in the projected path of the cargo container. Two or more separate wheeled decks serially work together to levitate the cargo container along its intended path.

The moving decks may reside beneath a thin false floor, which is situated above the region where the moving decks (25) operate. A user pushing the cargo must walk on the false floor, which is situated above the moving decks and below the levitated cargo. The false floor has stanchions or other strengthening and structure to support other traffic over the false floor, which also provides spaces between the stanchions for the moving decks to traverse.

In the event that a thin flat false floor would not provide enough support for the weight expected to rest or travel on it, alternative versions of a false floor may be used with moving decks. Keeping in mind that magnets repelling each other should be in close proximity, the floor can have a grate of thicker strong beams incorporated into it, with regular holes or openings which match up with the pattern and shape of actuated magnets on top of the decks, so that a deck can align itself underneath the grid floor, and the actuated magnets can extend up along the openings in the grate, moving close to the magnets on the underside of the cargo. As with the large thin false floor, the decks would need to steer around the floor stanchions.

The moving decks may also operate on top of a floor, or the ground, without a larger false floor. In this case, a false floor is integrated into the top of the movable deck allowing a user pushing the cargo to walk over the movable deck which has securely immobilized, without stepping on the underlying lower array of actuated magnets.

The lower array of actuated magnets atop the moveable decks can also levitate, stabilize and accelerate/decelerate the cargo container across the moveable deck's surface, eliminating the need for a user or external force to push or guide the cargo. A series of two or more decks work together to form a path and magnetically support the cargo container along the path. Without a user walking over the moving decks, a false floor may not be necessary.

While the preceding descriptions assume that loads are being carried across a substantially level plane, any of these implementations using actuated magnets may also function on slopes and gradual changes in elevation. In the case of carrying loads across a surface with a generally constant elevation, the moveable decks may also have the ability to adjust its height on all sides of the deck, from one side of the deck to the other, so that the top surface of the deck is substantially level, even if the underlying terrain is not. The moveable deck in front of the levitated cargo container sets itself at a height substantially the same as the height of the moveable deck currently levitating the cargo container. As the cargo container passes onto the next moveable deck, the first moveable deck unsets itself and travels to the next spot of the projected path, and sets itself again in a substantially level configuration.

If the terrain is downward sloping, then the next moveable deck must raise its top surface to be substantially on the same plane of the deck already holding the levitated cargo. The moveable decks will communicate with each other, so that each deck knows its relative top surface height in relation to the other mover deck. If the downward slope is steep, before passing the cargo onto the next moveable deck, the moveable deck with the cargo may stabilize the cargo, and then lower its top surface while the next movable deck may raise its top surface so that the planes of the two decks are at the same altitude, and the cargo container can be passed from one deck to the next.

If the terrain is upward sloping, then the next moveable deck must lower its top surface to be substantially on the same plane of the deck already holding the levitated cargo. Additionally, before passing the levitated cargo to the next deck, the current moveable deck may stabilize the cargo, and then raise its top surface so that the planes of the two moveable decks are the same, and the cargo container can be passed from one deck to the next.

So long as the possible adjustment in height of each moveable deck exceeds the elevation change of the terrain across the length of the deck, then elevated cargo can be passed in a continuous fashion.

In another embodiment of the moveable decks, each lower moveable deck can be moved using an underlying bed of electromagnets, instead of having wheels. In this embodiment, the underlying electromagnets would simulate small offset arrays, by turning each magnet on to simulate a raised magnet; off to simulate a lowered magnet; higher power to simulate an offset magnet moving upward and nudging the object upwards; and lower power to simulate an offset magnet moving downward and dipping the object downwards at that location. On its bottom surface, the moveable deck would have an array of permanent magnets, which the underlying bed of electromagnets acts on to levitate and relocate the moveable deck. The mass of each unloaded moveable deck is much less than that of the cargo to be moved. The electromagnets use a large but manageable amount of electricity to levitate, stabilize, and move the empty decks. When a deck reaches its destination as part of a path, the underlying electromagnets gradually turn off to set the deck on the ground. When the deck is set and immovable, it is ready to actuate its own actuated permanent magnets to levitate the heavy load which begins to travel across the set deck.

Integration with existing electromagnet movers: The moveable decks can be integrated with, or rest atop an electromagnet mover, such as those manufactured by Planar Motor or Bechoff These mover systems suffer from low load capacity and high energy requirements. By integrating our moveable deck system with these planar mover systems, we endow these systems with heavy load capabilities, with the capability of lifting hundreds and even thousands of pounds with our actuated magnet system. Similar to the previously described deck embodiments, the moveable deck incorporating the lower bed of actuating magnets is transported from one location to the next by the underlying planar motor system, and is set down one after the other to transport a levitated cargo container across the moveable deck surfaces.

In all of the cargo transport embodiments, the cargo container can be a platform, bucket, box, crate, bed, chair, or other object which can carry a load or person or animal. The cargo container can be replaced with an item to be moved which can itself be directly levitated, so long as one or more magnetic arrays can be securely attached to or incorporated into the underside of the item, and the item can be balanced according to its center of gravity. Shifts in the load can be handled by the rails in path embodiments, and by stabilizing movements of actuated magnets.

Magnet sizes within the lower array may vary, and the magnets attached to the levitated cargo container may not be of the same size, shape, type and strength as magnets within the lower array.

In our early research, we found that when raising/offsetting magnets from the lower array underneath magnets of the upper array, the levitation force on the upper array increased. We later observed that when magnets from the lower array are offset above the non-offset bed of magnets within the lower array, the levitated array magnets are also moved further away from the non-offset bed of magnets within the lower array. This displacement of the levitated array magnets from all of the adjacent non-offset magnets within the lower array is important because it moves the levitated array (partially or totally) out of range of the attractive forces from these adjacent lower array magnets. The repulsive forces from the magnets raised underneath the levitated array continue to act on the levitated array, while the attractive forces from adjacent bed magnets which had been competing with the repulsive forces are now substantially reduced. The result is increased levitation forces per unit area. Furthermore, using the observation that adjustments of spacing between levitated magnets reduce adjacent magnet attractive forces, we can now better describe potential optimum upper array geometries.

The optimum configuration for a levitated upper array of magnets may be determined by optimizing the levitation forces per unit area between an upper array and the lower offset array. Since we have shown through simulations that when 1-inch by 1-inch lower array magnets are shifted approximately 105% (or separated by a lateral gap 5% the width of the magnet), attractive forces between the adjacent shifted magnet and the levitated magnet are greatest, we know that appropriate spacing is needed between each magnet in the upper array and the offset magnets within the lower array to generate optimum forces per unit area on the levitated magnet and therefore the levitated platform. Exemplary designs that incorporate spacing into the levitated array design include a perimeter, an X shape, a checkerboard and a pattern of small squares, as shown in FIG. 8. In order to lift and move levitated arrays with these designs, the actuated offset magnets within the lower array would optimally mirror the levitated array design, with additional strategically positioned offset magnets to create the horizontal forces needed for movement.

The spacing that separates the magnets in an array does not need to be the same for the levitated array and the lower array, nor does it need to be uniform. The magnet spacing in the levitated array can, for instance, be larger than the magnet spacing in the lower platform array, and can be optimized for different applications. For instance, in one application the magnet spacing may be optimized to produce maximum lift, while a different array spacing may produce maximum horizontal forces. Furthermore, both the lower offset array and/or the levitated array could include functionality allowing the magnet spacing to be dynamically controlled, so that the magnet spacing can be changed as a function of time or depending on the task to be performed. The levitated array may also include functionality for changing its geometry.

The foregoing cargo transport embodiments are assumed to be for the purpose of moving a load from one place to another, and they all serve that purpose—reaching a goal. However, sometimes the journey is what's important, as in an amusement park ride. The levitation systems described herein can be used to create a ride with virtual reality features, transporting riders along a path, providing acceleration and deceleration, bumps, spins, and other haptic and proprioception effects familiar to Disney World amusement park visitors.

In contrast with traveling from point A to point B, the purpose of the next set of embodiments is to support and make a person feel like they are locomoting through space, when in fact they remain in one spot, similar to a treadmill.

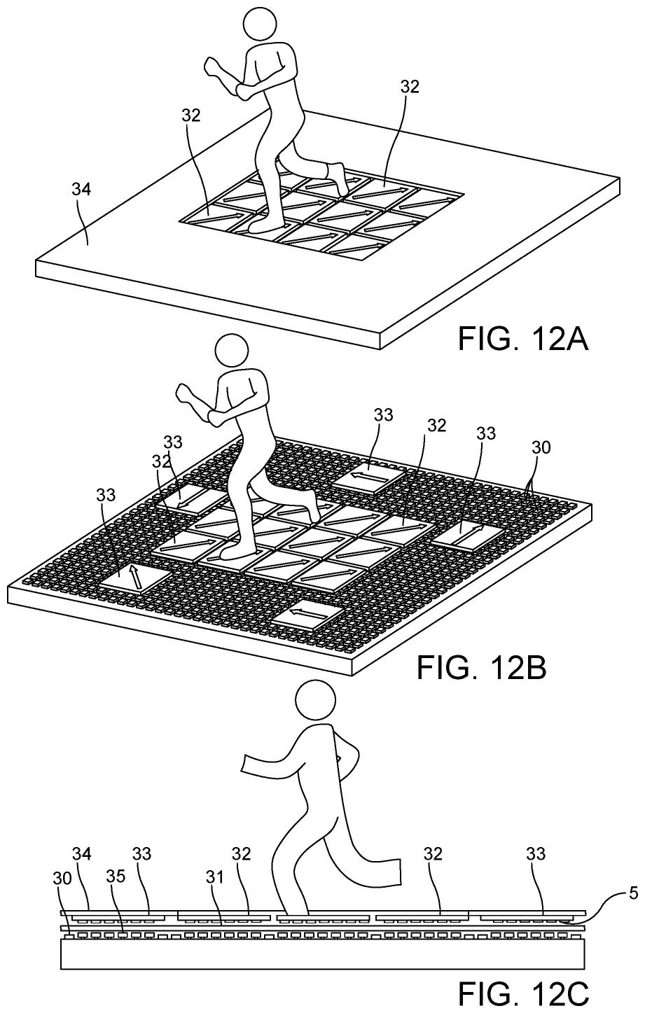

In a treadmill embodiment shown in FIGS. 12A, 12B and 12C, a lower bed of actuated magnets (30) in an array formation rests under a lower false floor (31) which is capable of supporting a person's weight. There is a central “walking area” portion where levitated platforms (32) are exposed, and a “return area” outside of the walking area, where an upper false floor (34) capable of supporting a person's weight covers any levitated platforms (33) which are not in the walking area. In the central walking area, multiple small platforms (32), each having a magnet array (5) on the underside, levitate above the lower false floor (31), in a rectangular grid covering the entire walking area, with very little space between levitated platforms. Each platform is levitated and stabilized by small raised offset arrays of magnets (35) from the lower bed of magnets (30), as described above. A user steps onto any one or combination of the levitated platforms with a first foot, and begins to walk, pushing backwards with the first foot. In response, the entire rectangular grid of platforms moves backward, with additional platforms from the return area joining the grid at the front, so that the entire walking area remains covered. The user steps with a second foot onto a second single or combination of levitated platforms in the rectangular grid of platforms. This process of the levitated platform then sliding back under the walker's body is repeated, and a stream of levitated platforms moving in the opposite direction of the walker's intended direction are placed before the walker, presenting the simulated experience of walking in a straight line. Each platform adaptively and dynamically supports the weight of each footstrike to minimize dips and bounciness. Assuming the user moves their legs to walk in a forward motion, all of the platforms in the walking area move backwards at the same speed as the user's foot. When a foot lifts off of the levitated platforms to step forward, the levitated platforms, now free of load, continue backwards towards the back of the walking area, supported by underlying offset arrays of magnets, and when they reach the back edge of the walking area, are carried to the return area of the apparatus, through a slot which leads underneath the upper false floor to the return path beside the walking area. The levitated platforms are concealed as they travel underneath the upper false floor, and are carried around to the front of the apparatus, where they emerge from another slot to join the grid over the walking area, ready to support a foot again. Multiple levitated platforms travel around the loop in this way, so that levitated platforms are always ready in place to support the user's next footstep.

As the walker (runner) changes their walking speed, the speed of each of the levitated platforms under the walker is adaptively controlled to respond to this change in speed. The system allows for instantaneous change in speed of the levitated platforms, very closely simulating the start and stop motions of natural walking or running.

We compare a traditional treadmill system with our levitated system. In a traditional treadmill, rotary motors and pulleys are used to move a flexible running surface around a continuous loop. The motors, belts pulleys etc. all have significant mass and inertia which is directly coupled to the motion of the running surface. To change the direction of the running surface, the rotation of the drive system must change rotational direction. The inertia of the system however slows the response time of the system making it difficult to undergo rapid changes in direction. By contrast, the levitated system decouples the motion of the control system from the motion of the mover. The control system consists of small actuated magnets which move perpendicular to the moving surface. The small mass allows for rapid changes in drive force, and the inertia of the drive system is orthogonal to the mover surface so the inertia of the mover does not slow the response time of the actuators.

The speed and direction of the levitated platforms in the walking area can be controlled with user input, as in a common exercise treadmill—higher and lower speed, and forward or backward. The platforms could also be sloped continuously from one end of the walking platform to the other, to mimic walking up or down a hill. To slope the platforms continuously across the false floor walking area, lower array actuated magnets at the front of the walking area would be extended higher (closer to the false floor) and the extension height of actuated magnets would gradually decrease, simulating the slope desired to impart on the levitated platforms.

To avoid gaps between the levitated platforms, in the embodiment where motion is constrained to only forward and backward motion, non-magnetic material may be used to connect each of the permanent magnets within the levitated platform, and to interconnect the levitated platform to other levitated magnetic platforms, providing a solid barrier thereby preventing the walker from stepping through gaps between magnetic platforms, and impacting the false floor.

In an alternative approach to generating a slope, the entire lower array and its false floor could also be sloped, also providing the simulated effect of a hill. In either approach to generating a slope, if the walker stops, the lower arrays will apply a horizontal force to the levitated platform, thereby maintaining the platform's (and the walker's) position. This horizontal force is exerted on the platforms by varying height of appropriate offset magnets, as previously described.

Each of the platforms can have covers (either permanent or replaceable) mimicking different exercise surfaces, like a wooden basketball court, or a grass field, or synthetic turf, or a polyurethane or rubber running track.

With slots allowing platforms to enter and exit the walking area only positioned in the front and back, the preceding treadmill embodiment only allows forward and backward locomotion.

Sensors are needed for feedback adjustments to the underlying offset arrays of magnets, to stabilize the levitated platforms, to keep them balanced, and to handle the added force of each footstrike.

One possible stabilization scheme includes a feedback loop that senses the change in angle and vertical displacement of a levitated platform, and causes the actuators to respond to counter those changes. With a projected need to sense displacements at an accuracy of smaller than a millimeter, there are a variety of sensors that are viable, including optical, capacitive, inductive, hall-effect, and ultrasonic sensors. We precompute the actuator displacements needed to provide the restoring. Once a movement of the levitated platform is detected by the sensors, the actuators are activated to provide the restoring force.

The treadmill can also be constructed with a walking area in the center, and a 360° covered return path on all sides of the walking area. This treadmill embodiment can be limited to forward and backward, or it can be an omnidirectional treadmill allowing the platform grid to move in any direction in the horizontal plane, and including slots on all sides where platforms may exit or enter the walking area as appropriate, to simulate 360° freedom of motion.

Where motion can be in any direction on the levitated platform plane, to eliminate or minimize gaps, the levitated platforms can be of a multitude of shapes, which minimize gaps between adjacent platforms, such as square, triangular, or hexagonal.

Alternatively, a levitated magnetic platform package (consisting of the levitated magnetic platform and non-magnetic material that interconnect and bind each of the permanent magnets within the levitated platform) may be so constructed to be larger than the offset array that is controlling the levitated magnetic platform package. By positioning offset arrays at slightly different heights (and not all in the same plane), the levitated platform packages will overlap, eliminating any gaps between the levitated platform packages and the floor. Furthermore, because the levitated platform packages are larger than the offset arrays, this allows for the required spacing between the offset arrays, thereby enabling the desired levitation lift force.

The foregoing treadmill embodiments allow pre-planned motion—forward or backward, at a preset speed. In order to accommodate a user's unplanned movements, for example for a smoother running experience or a virtual reality application, more sensing and artificial intelligence are used. In these embodiments, by using sensors on the walker, embedded in the platforms, in the lower array, or external sensors such as cameras, the system detects a walker's instantaneous change in desired speed, by calculating for example the user's stride length and rate, the location, and the time of impact, and adjusts the speed of the underlying platforms to simulate the walker's intended pace.

As the separation between two repelling magnets decreases, the magnetic forces increase as 1/r³ where r is the magnet-magnet separation. This scaling helps mitigate the possible problem of a footstrike causing a levitated magnet to strike the false floor. As the two magnets approach each other and the levitation gap shrinks, the levitation force increases dramatically, which would help prevent collisions in a levitated array application. These forces were calculated with ¼ inch thick magnets. Using thicker magnets on the lower array, levitated array, or both, would further increase the levitation force at small levitation gaps.

In a dynamic case such as the treadmill application, the offset permanent magnet based actuated system must respond to changes in the levitated load by moving the magnets in the lower array vertically to offset the change in weight on the levitated array. We calculated the difference in dynamic power consumption by comparing a single levitated permanent magnet over a single coil vs a single levitated permanent magnet over a permanent magnet. For this analysis, we did not consider the power required for active feedback, or the inefficiencies in the linear actuator. Therefore, this analysis provides a lower bound to the power required in each system.

For the electromagnetic coil, the power is obtained from P=i²R, where i is the coil current and R is the coil resistance. For the permanent magnet, the power is computed by first computing the energy from E=∫₀^{T}^{ₘₐₓ}F·dz where F is the vertical force and dz is an increment of vertical distance as the actuators move to respond to the vertical load, and Tₘₐₓ is the total time for the impact (300 ms for a footfall). The average power is then P=E/Tₘₐₓ.

Note that the actuated magnets only require power over one half of the impact curve. For a 2 lb dynamic load, the peak power to balance the impact curve for the actuated magnet is a few watts (average power <1 W) while the peak power required in the electromagnetic case is approximately 1 kW (average power approximately 500 W). This analysis indicates that the electromagnetic levitation configuration requires approximately 500 times (or greater) the power of the actuated permanent magnet configuration. We can extrapolate these single actuator values to a larger array. A comparison of the average powers for the two systems for different dynamic loads is summarized here:

| | Levitated Dynamic Load (10 × 10 array) | | | | | |
|---|---|---|---|---|---|---|
| | 100 lb | | 150 lb | | 200 lb | |
| Permanent Magnet | 34 | W | 51 | W | 66 | W |
| (mean Power) | | | | | | |
| Electromagnetic | 14.4 | kW | 32 | kW | 58 | kW |
| Coil (mean Power) | | | | | | |

An electromagnetic coil system would require tens of kilowatts per square foot to levitate 100 or more pounds, while the permanent magnet system requires less than 100 W. The permanent magnet system can reasonably be ramped up to lift and transport hundreds or thousands of pounds.

The bed of magnets may track and anticipate where the user's foot will fall. This may be accomplished with sensors in the bed of magnets, sensors in the platforms, video monitoring and communication between the bed and the platforms, as in the transport implementations. In addition, a motion tracking suit or shoes worn by the user, using technology such as that described in U.S. patent application Ser. No. 14/550,894, can convey information which can be used to calculate where and when the platforms and underlying offset arrays should be, and how they should move in order to always meet, support and smoothly carry the user's feet.

Actuated permanent magnets within the bed may be combined with electromagnets, which are coils of wire wrapped around each magnet. The electromagnets can provide the horizontal forces to move the unloaded levitated platforms, or fine tune the forces on the levitated magnets for active feedback control. In this scenario, the underlying permanent magnets provide the primary levitation forces, while the electromagnets may provide the horizontal forces for motion and the adaptive feedback forces for platform stability. For example, each individual actuator and magnet in the bed may be surrounded by an electromagnetic coil. Any magnetic force on a levitated magnet above is a sum of the force due to the offset magnet and the electromagnetic coil. The force from the electromagnetic coil will add or subtract from the force due to the offset magnet, depending on the direction of the current in the coil.

The electromagnets allow for fine tuning the position of the levitated magnets within the upper array, such that small, fast changes in position are possible without having to use the mechanical actuator to change the lower array permanent magnet's position. In situations where fast, dynamic adjustments in levitation forces are required, such as in high speed adaptive feedback scenarios, the offset subarray magnets provide the primary levitation forces, whereas changing electromagnet forces provide necessary fine tuning vertical, horizontal and torque force adjustments, and they may also provide the horizontal forces to impart motion to the levitated platform.

An alternative to supporting the user's feet on separate platforms would be to provide one platform incorporating an upper array of magnets for the user to stand on like a skateboard, Wii balance board, surfboard, snowboard or Segway. The user balances on the board, and can shift their weight and even take small steps on top of the board while the board is levitated. The underlying offset magnetic array moves to stabilize the board, and also can move the board to simulate movement as in a virtual reality ride, allowing the user to experience turns, bumps, rotation forces, motion and accelerations. In this implementation, multiple levitated platforms would not be necessary.

A third alternative includes a treadmill system with only two platforms which always stay in the treadmill walking area, and track the user's feet, moving backwards and forwards. Each platform (supported by an underlying offset magnet subarray) meets the user's foot as it falls, moves with the foot backwards to simulate a natural walking or running motion, and then as soon as the foot lifts, the underlying offset subarray causes the levitated platform to reverse direction and track the position of the forward moving foot, so that the levitated platform is in the correct location to support the next footfall. Since some users have a running form which causes each foot strike from both the left and right foot to strike a midline, or even cross a midline, the path of each levitated platform may be in an arc, as it first follows the foot backwards, and then arcs forward to avoid the next platform which is in its backwards motion along the midline. In this embodiment, the surface area of the levitated platform may be only slightly larger than the surface area of a person's shoe. To provide the required levitation forces over this smaller area, thicker magnets are used in one or both of the bed of magnets and the levitated platform. The levitated platforms may also be cushioned along the outer edge, for safety in case of system malfunction.

Another embodiment involves the user wearing a platform on each foot incorporated into shoes. While a serious runner may not want to have a magnetic array (platform) strapped to their feet or integrated into a shoe, this embodiment may appeal to gamers. Only two levitated platforms would be necessary. Underlying magnetic offset arrays must anticipate where and when to raise up, in order to support each footstrike, and then support each platform as it moves, simulating the motion that the user intends (such as walking, running, hopping, or even skating). For example, a user simulating playing basketball could lift the left foot, push off with the right foot, intending to move left, land, then jump up for a shot, then land, then run backwards. In order to support this motion, the underlying magnets would already be supporting both feet in place, then provide a feeling of resistance when the user jumps to the left, then support both feet as they land, providing a feeling of resistance from the right through offset magnets generating a horizontal force to the left, then support both feet as they push off for a vertical jump, again support both feet as they land, then support each footfall as the user begins to backpedal. In order to allow the user to maintain balance, the offset array supporting each levitated platform for each footfall must stabilize the platform minutely, and keep it in place.

Since the surface area of each levitated platform in this platform-shoe embodiment is smaller than that of the levitated platforms used for previously described treadmill embodiments, stronger magnets are used. Alternatively, or in addition, each levitated platform may expand when it is weight bearing, to provide more surface area, and contract to foot size when it is not weight bearing, so that it is less likely to make contact with the runner's other leg during a forward swinging motion while running, for example.

Extensive sensing, communication between all portions of the machine and the user's body, and artificial intelligence are necessary to support quick, unpredictable, varied motions of a user.

In yet another embodiment, rather than using the levitated platforms to simulate a walking or running motion, the levitated platforms can make up a moving walkway system. The moving walkway system consists of a bed of actuated offset magnets, multiple levitated platforms each with an array or arrays of permanent magnets attached underneath, a return path for the levitated platforms which may reside under a false floor, and an entry and exit point for the walker between which lies the walking zone.

The levitated platforms in the walking zone move together at the same speed in a forward motion until reaching the end (the exit) of the walkway, at which point they are redirected and circulated back to the start (entry) of the moving walkway. Each of the levitated platforms is supported by actuating offset magnets to provide the required levitation and stability control forces.

In a related system embodiment, the moving walkway only has levitated platforms near the walking person. The levitated platforms for each walking person consist of one or more platforms on the left side, and one or more platforms on the right side, corresponding to the left and right foot of the walker. As the walker takes a step forward, the levitated platforms corresponding to either the left or right side of the person slide forward at the appropriate speed to provide a stable walking surface. This process is repeated for alternating sides until the person reaches the exit point of the moving walkway.

A third embodiment of the moving walkway, similar to the original treadmill application pictured in FIG. 12A B and C, has a set of levitated platforms for each walker, consisting of several platforms in the walking area, which the walker stands or walks on, and several more platforms beside the walker, hidden under a false floor. The entire set of platforms moves forward along the walkway with the walker when the walker stands still. If the walker walks forward while being carried forward by the moving levitated platforms, then the extra hidden platforms must circulate into the walking area for the walker to step on, while the platforms in the walking area circulate out of the walking area and eventually around in front of the walker. After each walker reaches the exit, their set of platforms circulates back to the beginning of the walkway for the next user.

Power Transfer/Energy Harvesting Applications

The underlying invention and method of using magnetic repulsive force to move objects can be also be used to transmit energy through a nonconductive gap, without physical contact with very high voltage isolation and high power transfer at potentially low cost. We describe three separate embodiments of this voltage isolated power transfer method, and it will be understood that the invention is not to be limited to the disclosed embodiments, but on the contrary, is intended to cover various modifications and equivalent arrangements included within the spirit and the scope of the appended claims.

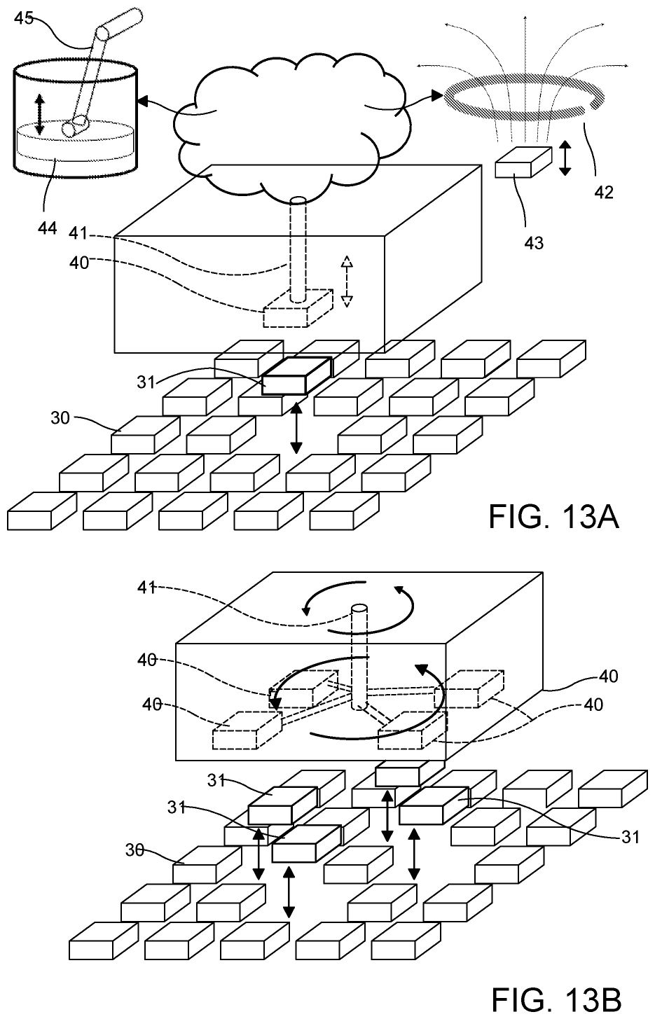

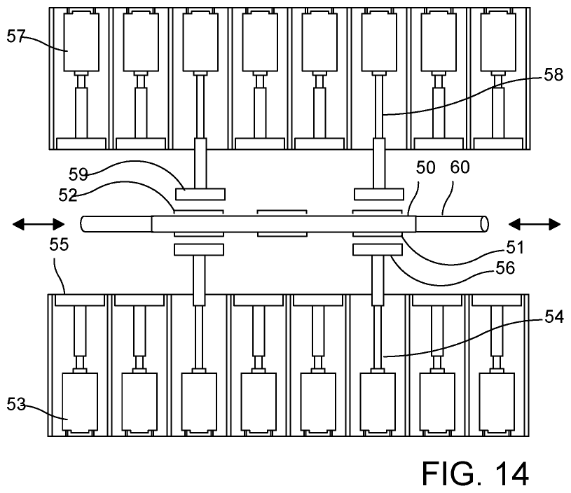

In a power transfer coil embodiment, illustrated in FIG. 13A, an actuated magnet (31) moves up and down, repelling and lifting a receiving magnet (40) up and down. The receiving magnet is attached to a vertical rod (41) which allows the receiving magnet (40) to move up and down, but keeps the receiving magnet centered in a coil (42) which is located above the offset magnet. The vertical rod may have one or more additional magnets attached further above (43) When the receiving magnet (40) is itself traveling towards or through the coil above, or when it causes additional magnets to move back and forth through a coil, this movement can be used to create electricity. The resulting oscillation of a magnet creates a changing magnetic flux in the coil. By Lenz's law, an electric current, i, is created in the coil creating an open circuit voltage (assuming an open coil) which can be used to power an electrical device or stored in a battery for later use. We illustrate using an actuated offset magnet to generate the oscillating magnetic field, but any means of generating an oscillating magnetic field is incorporated as part of this invention.

Multiple coils may be contained within the system, and an oscillating actuated magnet underneath or travelling through each of the coils creates a changing magnetic flux in each of the coils, thereby creating greater power transfer.

An additional embodiment using the same type of power transfer coil system may use an actuated magnet to push a receiving magnet and the attached rod in a direction other than vertical. A separate return mechanism, like a spring or repelling magnet, is indicated for a horizontal model.

In a power transfer piston and shaft embodiment also shown in FIG. 13A, an actuated magnet (31) moves up and down, repelling and lifting a receiving magnet (40) up and down. The receiving magnet is attached to a piston (44), so that when the receiving magnet (40) moves up and down, it pushes the piston up and then allows it to come down. This reciprocating motion can be used to power a mechanical machine, or to generate electricity. Alternatively, the receiving magnet can be attached with one or more pivoting connections to a shaft or series of shafts (45), such that up and down movement of the receiving magnet causes a rotating motion on the other end of the shaft. This rotating motion can be used to power a mechanical machine, or to generate electricity.

In another power transfer piston and shaft embodiment, multiple actuated magnets move up and down, and act on multiple receiving magnets, each housed in a cylinder, where each receiving magnet acts as a piston when an actuated magnet directly beneath it is oscillated. Each of these pistons may be connected via a linkage to the same shaft, and the timing of the “firing” of the actuated magnets beneath each piston is such that the shaft to which each of pistons are connected to spins with more speed, or with more force, resulting in greater electrical power output from the generator.

In a power transfer rotating embodiment shown in FIG. 13B, actuated lower magnets (31) are used to apply torques to a receiving upper arrangement of magnets (40). The magnets in the upper arrangement are attached to a vertical rod (41) which spins along its axis. Lower magnets (31) are raised up towards the upper magnets with appropriate placement as to provide horizontal forces to the upper magnets, causing a torque about the vertical axis. The levitated upper array (40) will begin to spin with an angular speed co due to this torque.

In this way, an upper array can be rotated and torques applied such that the attached vertical rod spins continuously along its Z axis, powering an attached generator. This spinning capability enables a wireless means of power transfer to a levitated platform, wheeled cart, battery or to any system that contains a lower array of actuated magnets, and an upper receiving array so configured to allow the receiving array to incur spinning motion.

In one example, a levitated generator platform is shaped roughly like a box, with a generator fixed inside the box. The generator's internal has a rotor attached to the vertical shaft, either encircling the shaft, or connected end to end. The vertical shaft has the freedom to spin on its vertical Z axis, and in spinning it also spins the generator's rotor. The vertical shaft is housed partially within the levitated generator platform such that it spins freely, but does not otherwise move within or out of the box of the generator platform. The lower end of the vertical shaft extends below the generator platform, and a spinnable levitated platform with an array of magnets on its underside is attached to the lower end of the vertical shaft, so that the vertical shaft, the attached generator rotor, and spinnable levitated platform can spin together, while the generator platform and remaining attached generator components remain stationary.

Magnets on the lower perimeter of the generator platform's extended sides enable the generator platform to be levitated and moved by an underlying bed of actuated magnets. When the generator platform experiences no levitation force, then it rests on the floor and is stationary. At this point, raised offset magnets from the underlying bed of actuated magnets can apply a series of torque forces to the magnets attached underneath the separate spinnable levitated platform, causing the spinnable platform, vertical shaft and the generator's rotor attached to the shaft, to spin. As the spinnable array spins, it generates electricity via the spinning rotor within the electric generator. In this manner, power is transferred from a bed of actuated magnets into the spinnable array, and further into the electric generator of the generator platform. The power may then be transferred to a battery or device which is connected to, integrated into, or mounted on top of the generator platform.

Other wireless power transfer embodiments include means of converting reciprocating or oscillating vertical or horizontal motion within the levitated platform into circular motion of a generator's shaft. One or more permanent magnets within the levitated platform may be caused to oscillate vertically or horizontally through the repeated actuated motion of one or more magnets within the lower array. The oscillating motion can be converted to a rotational motion, as is commonly done within Stirling engines, and reciprocating or piston engines.

A levitation system for a planar actuator system, based on offset magnetic arrays

This planar actuator system embodiment, shown in FIG. 14, consists of a levitated magnetic platform (50) with arrays of magnets both on its top side and its bottom side, a lower actuated array of magnets, and an upper actuated array of magnets.

The levitated magnetic platform (50) consists of a magnetic N facing side (51), and a magnetic S facing side (52). The N facing side can face in either direction, but for this discussion, the N facing side is down, and the S facing side is up. Therefore, the lowest array of magnets (55, 56) is N facing up, towards the levitated magnetic platform (50). The N facing lower actuated array (53, 54, 55, 56) is used to provide a levitation force and adaptively control the levitated platform. An upper actuated array is S facing down, towards the levitated magnetic platform. The S facing down upper actuated array (57, 58, 59) is also used to provide a counter levitation force and adaptive control of the levitated platform. The S upper and N lower offset arrays together stabilize the levitated platform, and control its direction, as the actuated offset array locations travel in a back and forth manner, across the upper and lower beds due to individual magnets within the upper and lower beds being raised or lowered to the offset array position, as needed.

The levitated magnetic platform can be packaged within another object, selected for, as examples, its durability, weight, dimensions, adhering capabilities, i.e. a levitated magnetic platform package.

A rod (60) may be attached to one side of the levitated magnetic platform (50) (or levitated magnetic platform package), or a rod may be attached to both sides of the levitated magnetic platform. As the levitated magnetic platform is reciprocated back and forth, the rods alternate between extension and contraction position, providing the actuating motion.

In another planar actuator embodiment, the upper and lower arrays are not used, and instead the upper and lower offset arrays are permanently affixed along the intended reciprocating path of the levitated magnetic platform. Electromagnets interspersed within the offset arrays are turned on and off at the required current intensity to provide any necessary adaptive control, and to cause the reciprocating motion of the levitated magnetic platform.

Variations on this planar actuator system can be imagined, like a ceiling fan levitated above a lower array, and which is actuated (pushed into a spinning motion) by magnets above the fan. A sliding door may be levitated and pushed open and closed.

Magnetic Arrays for Attractive Forces

To increase the levitation (or repulsive force) and minimize the mass of magnets required, the invention covers the use of magnetic arrays with gaps between each of the magnets that make up the array, magnetic offset arrays made up of magnets with gaps between each of the magnets, and magnetic arrays (offset and levitated platforms) with the center magnets removed altogether.

These same concepts apply to attractive forces as well. Therefore, for a given surface, particularly for larger surface areas, a maximum amount of attractive force relative to magnet mass can be achieved by a combination of incorporating spacing between magnets within the array, and furthermore removing the center magnets from the array.

Moreover, in applications where it is desired to reposition the location of an attractive force, or to alternatively turn on or off an attractive force, an offset array as previously described except embedded with magnets with the opposite pole to the target magnetic platform can be used.

We claim:

1. A levitation and levitated transport system, comprising:
a base planar arrangement of permanent magnets,
wherein every said base magnet has a magnetization vector which points in a direction, and said magnetization vector of every said base magnet points in the same said direction, which direction is normal from said plane of said base arrangement; and
wherein every said base magnet is attached to a linear actuator which can lift said base magnet or magnets up in the said direction, above the said base plane, without changing the direction of said lifted magnets' magnetization vectors; and
wherein every said base magnet is separated laterally from its adjacent nearest neighbor magnets; and
one or more levitated planar arrangements of one or more permanent magnets,
wherein every said levitated magnet is rigidly attached to the underside of a levitated object; and
wherein every said levitated magnet has a magnetization vector which points in a direction, and said magnetization vector of every said levitated magnet points in the same direction, which direction is normal from said plane of said levitated arrangement, and which direction is opposite to the direction of each said base magnet; and
wherein said levitated planar arrangement of permanent magnets has a footprint, which is defined as the combined lateral area and pattern occupied by all of the said levitated magnets.

2. The levitation and levitated transport system of claim 1, further comprising:
wherein every said base magnet is separated laterally from its adjacent nearest neighbor base magnets by a spacing which is less than the smallest lateral dimension of a levitated magnet being used in the system.

3. The levitation and levitated transport system of claim 1, further comprising:
a first nonmagnetic false floor situated between the said base planar arrangement of permanent magnets and the said levitated planar arrangement of one or more permanent magnets, which false floor has a footprint and a plane which is parallel to the said base plane and the said levitated plane.

4. The levitation and levitated transport system of claim 3, further comprising:
a second nonmagnetic false floor situated above the said levitated planar arrangement of one or more permanent magnets, which second false floor has a footprint and a plane which is parallel to said first false floor.

5. The levitation and levitated transport system of claim 4, for use as a single-directional or omni-directional treadmill-like machine to support a human, further comprising:
wherein said levitated object comprises a multiplicity of levitated objects, each levitated object being configured to receive and support the weight of a human foot; and
wherein said the said footprint of the said second false floor is different from the said footprint of the said first false floor.

6. The levitation and levitated transport system of claim 1, further comprising:
wherein the said base planar arrangement of permanent magnets is rigidly attached onto a moveable object, deck or vehicle.

7. The levitation and levitated transport system of claim 3, further comprising:
wherein the said base planar arrangement of permanent magnets is rigidly attached onto a moveable object, deck or vehicle.

8. The levitation and levitated transport system of claim 1, further comprising:
wherein said levitated planar arrangement of permanent magnets comprises a plurality of magnets placed in a perimeter formation, and an area without magnets, which magnet-less area is situated inside the said perimeter.

9. The levitation and levitated transport system of claim 8, further comprising:
a plurality of permanent magnets, called the attractive magnets, each having a magnetization vector which points in the same direction as the magnetization vector of the said base magnets; and
wherein said attractive magnets are placed in said magnet-less area.

10. The levitation and levitated transport system of claim 1, further comprising:
wherein every said levitated magnet is separated laterally from its adjacent nearest neighbor magnets by a spacing which is not the same as the said lateral spacing between the said adjacent nearest neighbor base magnets.

11. The levitation and levitated transport system of claim 1, further comprising:
wherein every said base magnet is attached to a linear actuator which can lift said base magnet or magnets up in the said direction at least 0.25 cm above the said base plane, without changing the direction of said lifted magnets' magnetization vectors.

12. A levitation and levitated transport system comprising:
a base path arrangement of permanent magnets,
wherein said path arrangement has a width; and
wherein every said base magnet has a magnetization vector which points in a direction, and said magnetization vector of every said base magnet points in the same direction, which direction is normal from said plane of said base arrangement; and
wherein every said base magnet is separated laterally from its adjacent nearest neighbor magnets; and
a levitated planar arrangement of one or more permanent magnets,
wherein every said levitated magnet is rigidly attached to the underside of a levitated object; and
wherein every said levitated magnet has a magnetization vector which points in a direction, and said magnetization vector of every said levitated magnet points in the same direction, which direction is normal from said plane of said levitated arrangement, and which direction is opposite to the direction of each said base magnet; and
wherein said levitated planar arrangement of permanent magnets has a footprint, which is defined as the combined lateral area occupied by all of the said levitated magnets; and
wherein said footprint has a smallest lateral dimension, and wherein said smallest lateral dimension is at least half of the said width of the said base path; and
a set of 2 rails, 1 on either side of said base path, which rails are spaced appropriately so that said levitated object fits between said rails, and can move along and above the path and between said rails.

13. The levitation and levitated transport system of claim 12, further comprising:
wherein every said base magnet is separated laterally from its adjacent nearest neighbor base magnets by a spacing which is less than the smallest lateral dimension of a levitated magnet being used in the system.

14. The levitation and levitated transport system of claim 12, further comprising:
wherein said base path arrangement of magnets comprises a multiplicity of parallel base paths; and
wherein said levitated planar arrangement of magnets comprises a multiplicity of separate arrangements, the number of levitated arrangements matching the number of base paths, and the levitated arrangements being situated to mirror the placement of said parallel base paths, so that each said levitated arrangement is located generally above one of the said base paths at all times during use.

15. The levitation and levitated transport system of claim 13, further comprising one or both of:
wherein when comparing the said multiplicity of parallel base paths, the base path magnets and the lateral spacing between said base path magnets of a first parallel base path do not exactly match up with the base path magnets and the lateral spacing between said base path magnets of a second adjacent parallel base path; or
wherein when comparing the multiplicity of parallel levitated magnet paths mirroring the said multiplicity of parallel base paths, the levitated path magnets and the lateral spacing between said levitated path magnets of a first parallel base path do not exactly match up with the levitated path magnets and the lateral spacing between said levitated path magnets of a second adjacent parallel levitated path.

16. A method of levitation and levitated transport, using the system of claim 1, comprising the steps of:
raising one or more offset arrays of base magnets using said actuators, said offset arrays being configured to mirror one or more said levitated magnet arrangement footprints, and at least a portion of each magnet in said offset array being dynamically situated directly underneath a said levitated magnet arrangement; and
dynamically lowering to the base plane any raised offset base magnets which are not currently situated directly underneath a said levitated magnet arrangement.

17. The method of levitation and levitated transport of claim 16, further comprising one or more of the steps of:
raising one or more base magnets which are located beside a said levitated magnet arrangement, for the purpose of pushing said levitated magnet arrangement away from said raised base magnets using magnetic repulsive force; and
raising one or more base magnets which are located ahead or beside of a said levitated magnet arrangement which is laterally moving, for the purpose of slowing or stopping or redirecting said movement of said levitated magnet arrangement; or
lowering one or more raised base magnets which are located under one side of a said levitated magnet arrangement, for the purpose of causing said levitated magnet arrangement to move in the direction of said base magnets which are being lowered; or
raising one or more base magnets which are located under a said levitated object and beside a said levitated magnet arrangement, for the purpose of pushing, slowing, stopping, or redirecting movement of said levitated magnet arrangement.

18. A wireless power transfer system, comprising
a planar arrangement of one or more permanent driver magnets,
wherein every said driver magnet has a magnetization vector which points in a direction, and said magnetization vector of every said driver magnet points in the same said direction, which direction is normal from said plane of said planar arrangement; and
wherein every said driver magnet is attached to a linear actuator which can move said driver magnet or magnets in the said direction, away from the said plane, without changing the direction of said actuated magnets' magnetization vectors; and
an arrangement of one or more permanent pushable magnets,
wherein every said pushable magnet has a magnetization vector which points in a direction, and said magnetization vector of every said pushable magnet points in the same said direction, which direction is opposite from said direction of said driver magnets; and
wherein every said pushable magnet is attached to a reciprocating or rotating member of a generator, engine or machine.

19. A wireless power transfer system, comprising
a planar arrangement of one or more permanent driver magnets,
wherein every said driver magnet has a magnetization vector which points in a direction, and said magnetization vector of every said driver magnet points in the same said direction, which direction is normal from said plane of said planar arrangement; and
wherein every said driver magnet is attached to a linear actuator which can move said driver magnet or magnets in the said direction, away from the said plane, without changing the direction of said actuated magnets' magnetization vectors; and
an arrangement of one or more permanent pushable magnets,
wherein every said pushable magnet has a magnetization vector which points in a direction, and said magnetization vector of every said pushable magnet points in the same said direction, which direction is opposite from said direction of said driver magnets; and
wherein every said pushable magnet is configured to be pushed towards or through one or more coils, for the purpose of creating magnetic flux and therefore electricity.

20. A wireless power transfer system, comprising
a planar arrangement of one or more permanent driver magnets,
wherein every said driver magnet has a magnetization vector which points in a direction, and said magnetization vector of every said driver magnet points in the same said direction, which direction is normal from said plane of said planar arrangement; and
wherein every said driver magnet is attached to a linear actuator which can move said driver magnet or magnets in the said direction, away from the said plane, without changing the direction of said actuated magnets' magnetization vectors; and
an arrangement of one or more permanent pushable magnets,
wherein every said pushable magnet has a magnetization vector which points in a direction, and said magnetization vector of every said pushable magnet points in the same said direction, which direction is opposite from said direction of said driver magnets; and
wherein every said pushable magnet is attached to a platform and shaft which are configured to spin around the said shaft's Z axis; and
wherein said shaft is connected to a generator, engine or machine.
